(19) United States
(12) Patent Application Publication
(10) Pub. No.: US 2024/0428576 A1
(43) Pub. Date: Dec. 26, 2024

(54) TRANSFORMER WITH MULTI-SCALE MULTI-CONTEXT ATTENTIONS

(71) Applicant: QUALCOMM Incorporated, San Diego, CA (US)

(72) Inventors: Tianyu JIANG, San Diego, CA (US); Manish Kumar SINGH, San Diego, CA (US); Hsin-Pai CHENG, San Diego, CA (US); Hong CAI, San Diego, CA (US); Mingu LEE, San Diego, CA (US); Kartikeya BHARDWAJ, San Diego, CA (US); Christopher LOTT, San Diego, CA (US); Fatih Murat PORIKLI, San Diego, CA (US)

(21) Appl. No.: 18/613,263

(22) Filed: Mar. 22, 2024

Related U.S. Application Data
(60) Provisional application No. 63/509,590, filed on Jun. 22, 2023.

(51) Int. Cl. G06V 10/82; G06V 10/70; G06V 10/77

(52) U.S. Cl. CPC G06V 10/82; G06V 10/7715; G06V 10/87

(57) ABSTRACT

Certain aspects of the present disclosure provide techniques and apparatus for improved machine learning. A transformed version of image pixels is accessed as input to an attention layer of a machine learning model. A number of local attention operations to apply, in one transformer, to the transformed version of image pixels is selected based at least in part on a size of the transformed version of image pixels. A transformer output for the attention layer of the machine learning model is generated based on applying the number of local attention operations and at least one global attention operation to the transformed version of image pixels.

### CROSS-REFERENCE TO RELATED APPLICATION(S)

The present application for patent claims the benefit of priority to U.S. Provisional Appl. No. 63/509,590, filed Jun. 22, 2023, which is hereby incorporated by reference herein in its entirety.

### INTRODUCTION

Aspects of the present disclosure relate to machine learning.

Transformer network architectures provide state-of-the-art performance and versatility in many domains, and have recently been regarded as one of the most important recent advancements in artificial intelligence. Vision transformers in particular have found widespread use in computer vision tasks, such as classification, detection, segmentation, depth estimation, and the like. However, transformer-based model architectures are notoriously expensive in terms of computation and memory resource usage owing to their O(N²) complexity, which increases quadratically with respect to input size N. This complexity problem often prohibits using transformer-based model architectures for tasks with large data (e.g., images with many pixels), and additionally limits the range of devices upon which such model architectures can be deployed.

Some conventional attempts to reduce the complexity of transformer-based model architectures often do so with a significant reduction in accuracy.

### BRIEF SUMMARY

Certain aspects of the present disclosure provide a processor-implemented method for transformer-based attention, comprising: accessing a transformed version of image pixels as input to an attention layer of a machine learning model; selecting a number of local attention operations to apply, in one transformer, to the transformed version of image pixels based at least in part on a size of the transformed version of image pixels; and generating a transformer output for the attention layer of the machine learning model based on applying the number of local attention operations and at least one global attention operation to the transformed version of image pixels.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the present disclosure and are therefore not to be considered limiting of the scope of this disclosure.

FIG. 1 depicts an example of an attention function for composite slice vision transformer models.

FIG. 2 depicts an example slice attention layer architecture for composite slice vision transformer models.

FIG. 3 depicts an example data flow for slice attention in composite slice vision transformers.

FIG. 4 depicts example operations to slice input tensors for composite slice vision transformers.

FIG. 5 depicts an example workflow for saliency evaluations to enable dynamic attention.

FIG. 6 depicts an example transformer architecture for composite slice vision with dynamic attention.

FIG. 7 depicts an example architecture for composite slice vision transformers with dynamic attention.

FIG. 8 depicts an example architecture for composite slice vision transformers with multi-scale local attention using tensor downsampling.

FIG. 9 depicts an example architecture for composite slice vision transformers with multi-scale local attention using downsampled query tensors.

FIG. 10 depicts an example architecture for composite slice vision transformers with multi-scale local attention using downsampled key and value tensors.

FIG. 11 depicts an example architecture for composite slice vision transformers with multi-context local attention.

FIG. 12 is a flow diagram depicting an example method for generating attention output using multi-scale and/or multi-context composite vision transformers.

FIG. 13 is a flow diagram depicting an example method for generating composite slice vision transformer output.

FIG. 14 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for providing efficient transformer-based machine learning model architectures.

With state-of-the-art performance and versatility in many domains, transformer-based neural network architectures are a widely adopted technology for modern machine learning and artificial intelligence applications. Transformers are a popular contemporary neural network architecture because transformers have achieved high quality results on various types of challenging language tasks.

However, conventional transformer-based models are notoriously expensive due to inherently high complexity. At least some conventional transformers suffer due to a variety of problems, including quadratic computational and memory complexity with respect to input data sequence length (e.g., O(N²) based on an input data sequence length N), as well as reduced task performance (e.g., reduced accuracy) when modeling longer sequences.

Previous attempts to solve the technical complexity problem with transformer-based models have come at the cost of significant performance tradeoffs. That is, at least some conventional transformer-based models that have been made more efficient in terms of complexity, have also been made less performant (e.g., with reduced accuracy). For example, some transformer designs that specialize in optimizing for longer sequence modeling (but add additional overhead for shorter sequence modeling) are generally not universally applicable to different tasks.

To overcome these and other technical problems with conventional transformer-based model architectures, some aspects described herein relate to efficient transformer-based neural network architectures. In some aspects, the transformer-based neural network architectures use a serial composition of attentions at different scales applied to a stacked slice representation of an input tensor, and/or multi-scale positional embeddings that are instantly applied at attention time. In some aspects, the model architectures described herein may be referred to as “composite slice transformers” or “composite slice vision transformers” (CSViTs). Notably, with a slice size L as a hyperparameter, the efficient transformer-based neural network architectures described herein have complexity of

$$O ( NL + \frac{{N}^{2}}{{L}^{2}} ) ,$$

which is comparable to or even more efficient than linear complexity in practical settings, and which in any event is significantly more efficient than the complexity of conventional transformer-based models, O(N²).

As the efficient transformer-based neural network architectures described herein involve or use slicing (also referred to as reshaping) of an input tensor, some aspects described herein relate to overlapped or focal attention techniques that capture token interaction (where a “token” is an element or value in the input sequence) across slice boundaries seamlessly, preventing context fragmentation. The efficient transformer-based neural network architectures described herein can therefore achieve high accuracy in many different computer-vision tasks while reducing computational expense of transformer models.

### BRIEF INTRODUCTION TO SELF-ATTENTION

In aspects of the present disclosure, transformer-based architectures, which utilize (self-) attention functions to draw global dependencies between inputs and outputs, are described. An attention function can generally be described as a function configured to map a query and a set of key-value pairs to an output, where the query, keys, values, and output are all tensors (e.g., matrices and/or vectors). In some aspects, the output is computed as a weighted sum of the values, where the weight assigned to each value is computed by a compatibility function of the query with the corresponding key.

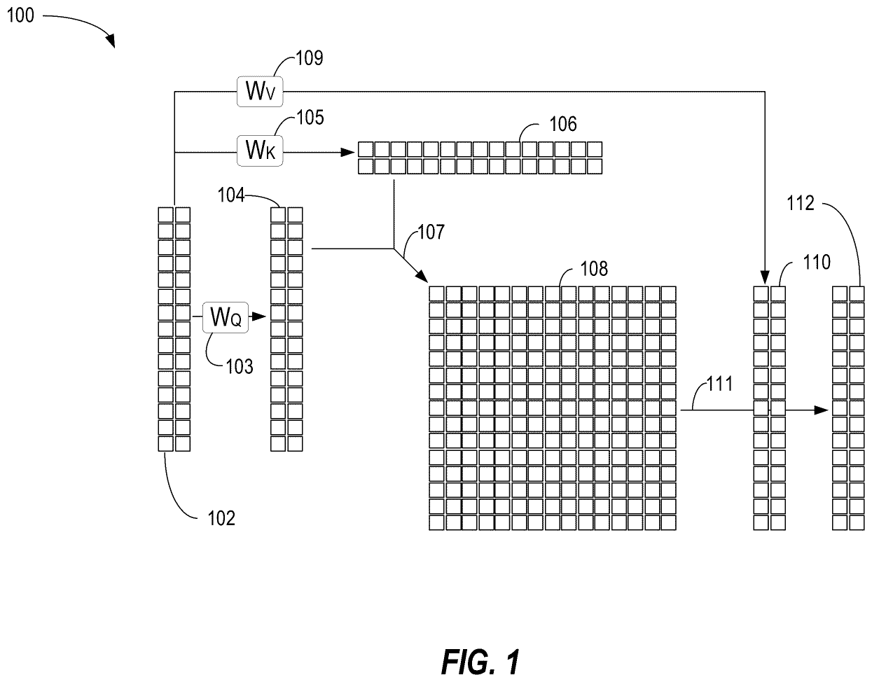

FIG. 1 depicts an example attention mechanism 100 for composite slice vision transformer models, in which an input matrix 102 (also referred to in some aspects as an input vector or an input tensor), which may include or be based on image data, is weighted by trainable parameters including a query weight 103 (also referred to as a query parameter and/or a trained query parameter), a key weight 105 (also referred to as a key parameter and/or a trained key parameter), and a value weight 109 (also referred to as a value parameter and/or a trained value parameter) to generate a query matrix 104 (also referred to in some aspects as a query vector or a query tensor), a key matrix 106 (also referred to in some aspects as a key vector or a key tensor), and a value matrix 110 (also referred to in some aspects as a value vector or a value tensor), respectively. That is, the input matrix 102 is weighted (e.g., multiplied) with a set of one or more learned query weights 103 (denoted W_{Q} in the illustrated example) in order to generate the query matrix 104 (also referred to in some aspects as “queries”). Sequentially or in parallel, the input matrix 102 is weighted (e.g., multiplied) with a set of one or more learned key weights 105 (denoted W_{K} in the illustrated example) in order to generate the key matrix 106 (also referred to in some aspects as “keys”), and the input matrix 102 is weighted (e.g., multiplied) with a set of one or more learned value weights 109 (denoted W_{V} in the illustrated example) in order to generate the value matrix 110 (also referred to in some aspects as “values”). In some aspects, these multiplications (to create the query matrix 104, the key matrix 106, and/or the value matrix 110) may be referred to as element-wise or Hadamard multiplications or products.

In the illustrated example, the query matrix 104 and the key matrix 106 are then aggregated or combined (e.g., using matrix multiplication of the two matrices), as depicted by arrow 107, to generate an intermediate matrix 108. Notably, in the illustrated example, the input matrix 102 can have dimensionality N×D (e.g., size N*D), where N and D are integers. After applying the learned query weights 103, the key weights 105, and the value weights 109, the resulting matrices may have equal size N*D. That is, as illustrated, the query matrix 104 and the value matrix 110 each have dimensionality N×D (e.g., size N*D), while the key matrix 106 has dimensionality D×N (e.g., size D*N).

However, as the intermediate matrix 108 is generated using matrix multiplication (e.g., as represented by the arrow 107) of the query matrix 104 and the key matrix 106, the intermediate matrix 108 generally has dimensionality N×N (e.g., size N²). As discussed above, this results in the O(N²) complexity in conventional architectures.

In the illustrated example, the intermediate matrix 108 is then weighted (e.g., multiplied) with the value matrix 110 (using operation 111, which may correspond to a matrix multiplication operation) to generate an output matrix 112, which may serve as output from the attention mechanism 100. In the illustrated example, the output matrix 112 is of the same dimensionality and size as the input matrix 102 (e.g., dimensionality N×D with size N*D).

### Transformers and Multi-Head Self-Attention

In some aspects, transformer layers in a neural network model can include a multi-head self-attention sublayer followed by a feed-forward network with an optional cross-attention sublayer (e.g., in the case of a decoder). The multi-head self-attention (e.g., the output matrix 112), which may serve as the main source of the sequence modeling capability of the transformers, is defined as the concatenation of self-attention outputs in all attention heads:

$$Y = concat [ {Y}_{0} , {Y}_{2} , … , {Y}_{H - 1} ] \qquad ( 1 )$$

where each of the outputs Yₕ∈ [symbol] ^{N×D} is a scaled dot-product attention computed from the input X∈ [symbol] ^{N×D} (e.g., input matrix 102) as:

$${Y}_{h} = softmax ( \frac{{Q}_{h} {K}_{h}^{⊤}}{\sqrt{d}} ) {V}_{h} = A {V}_{h} . \qquad ( 2 )$$

with queries Qₕ=XW_{q,h} (e.g., the query matrix 104 generated by multiplying the input matrix 102 and the query weight 103 for the specific head h), keys Kₕ=XW_{k,h} (e.g., the key matrix 106 generated by multiplying the input matrix 102 and the key weight 105 for the specific head h), and values Vₕ=XW_{v,h} (e.g., the value matrix 110 generated by multiplying the input matrix 102 and the value weight 109 for the specific head h) as linear transformations of the input X. In Equation 2, A represents the intermediate matrix 108, and is generated based on the queries and keys (e.g., according to

$$\frac{{Q}_{h} {{K}_{h}}^{T}}{\sqrt{d}}$$

) In some aspects, the weights (e.g., the query weight 103, key weight 105, and/or value weight 109) may be implemented as scalar values and/or as matrices (e.g., where the query weight 103, key weight 105, and value weight 109 may each comprise a matrix of weights). Here, it is assumed that the queries, keys, and values have the same hidden dimension

$${d}_{h} = \frac{D}{H} .$$

Thus, hereinafter, the head index h and scaling factor

$$\frac{1}{\sqrt{d}}$$

are omitted for simplicity. Denoting the query as qᵢ∈ [symbol] ^{1×d} at query position index i, and similarly to keys and values as kⱼ and vⱼ, respectively, the attention output at the ith token position yᵢ∈ [symbol] ^{1×d}^{ₕ} corresponds to:

$${y}_{i} = soft max ( {q}_{i} {K}^{T} ) V . \qquad ( 3 )$$

Due to the nonlinearity and normalization property of the softmax function, the computation of QK^{T} is performed to get the attention weight followed by aggregating the values. Thus, the computational complexities of the dot-product, QK^{T}, and the value aggregation by the attention weights, AV, are both O(N²) (and the memory complexity is also O(N²)) for A. Consequently, the self-attention is said to have quadratic complexity with respect to the sequence length N.

### Abstractive Attentions

With the assumption that softmax dot-product attention plays an important role in the sequence modeling capability of transformer models, abstractive attention retains the form of basic attention computation per Equation 3.

In some aspects of the present disclosure, abstractive attentions may be defined as a family of efficient attention approaches in which the lengths of the attention operands are reduced to M(<N) (e.g., to a shorter or smaller sequence or input size) by applying an abstraction function, such that the complexity of the attention is reduced accordingly. Abstractive attentions can be further categorized to either resolution-preserving or non-preserving attentions, according to which operands are chosen to be abstracted, where the preservation of resolution is between input and output sequences. That is, resolution-preserving attentions preserve the resolution of the input sequence, while non-preserving attentions do not. In some aspects, when the queries (e.g., the query matrix 104) are abstracted, the attention is called “resolution non-preserving attention,” and the abstracted attention also produces abstracted output. In some aspects, this categorization as preserving or non-preserving attentions is determined according to the given task. For instance, tasks such as language modeling and machine translation generally rely on high (or full) resolution at the output to be retained. In those cases, in some aspects, only the keys (e.g., the key matrix 106) and values (e.g., the value matrix 110) are abstracted while the query resolution is retained. The abstractive resolution-preserving attention of this case can be expressed as below:

$${y}_{i} = soft max ( {q}_{i} {{K}^{′}}^{T} ) {V}^{′} \qquad ( 4 )$$

$${K}^{′} = {[ {{k}^{′}}_{0}^{T} , ... , {{k}^{′}}_{j}^{′ T} , ... , {{k}^{′}}_{{M}_{k}}^{T} ]}^{T} \qquad ( 5 )$$

$${{k}^{′}}_{j}^{′} = {ϕ}_{k} ( \{ {k}_{j ∈ {Ω}_{j}^{′}} \} ) \qquad ( 6 )$$

where Ω′ⱼ denotes the abstraction range with the cardinality |Ω′ⱼ|=Mₖ for the j′th key abstraction k″ⱼ and ϕₖ(⋅):K_{Ω′}_{ⱼ}∈ [symbol] ^{|Ω′}^{ⱼ}^{|×d}^{ₕ}→K″ⱼ∈ [symbol] ^{1×d}^{ₕ} is a many-to-one abstraction function. The abstracted value V′ⱼ can be expressed similarly to Equation 6.

Resolution non-preserving abstraction may be used for tasks where the output resolution is not necessary or is less important, such as sequence-level classification problems. However, with additional processing leveraging representations at a lower layer (e.g., using cross-attention with input tokens), it is possible to restore the resolution in some aspects. Along with the keys and values abstractions (discussed above with reference to Equations 5 and 6), in some aspects the queries can be abstracted as:

$${q}_{i}^{′} = {ϕ}_{q} ( \{ {q}_{i ∈ {Ω}_{i}^{′}} \} ) , \qquad ( 7 )$$

and the attention for resolution non-preserving attention can be defined as:

$${y}_{i}^{′} = soft max ( {q}_{i}^{′} {{K}^{′}}^{T} ) {V}^{′} \qquad ( 8 )$$

where an attention output vector y′ᵢ is obtained at each abstract position i′. In some aspects, in order to restore the resolution of the output, a one-to-many mapping function ψ_{y} may be defined as:

$$\{ {y}_{i ∈ {Ω}_{i}^{′}} \} = {ψ}_{y} ( {y}_{i}^{′} ) \qquad ( 9 )$$

In some aspects of the transformer-based architectures described herein, as the output of the local attention maintains high (or full) resolution (e.g., because the queries are not abstracted), a computationally inexpensive broadcasting function may be used to restore the sequence length, i.e., yᵢ=y′ᵢ for i∈Ω′ᵢ, instead of restoring the resolution. Note that the term broadcasting, as used herein, generally describes how to treat arrays with different shapes during arithmetic operations. Subject to certain constraints, the smaller array may be “broadcast” across the larger array so that the arrays have compatible shapes (e.g., by copying or duplicating elements of the array to create an array of the desired size)). Broadcasting provides a means of vectorizing array operations.

### Multi-Scale Multi-Range Attention

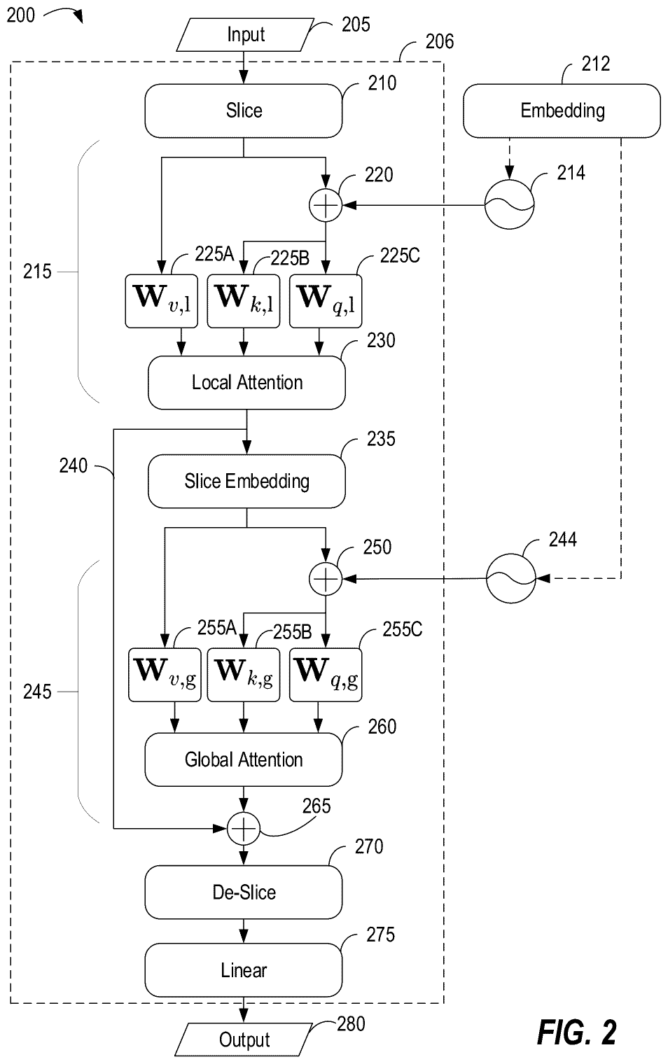

Although some previous abstractive attention and non-attention approaches have achieved sub-quadratic complexity (and even linear complexities for some methods), these prior approaches generally come at the cost of degraded performance (e.g., reduced accuracy) on benchmarks. However, the efficient transformer-based model architectures described herein leverage multi-scale attention by combining local attention and global attention and provide significant accuracy improvements (often outperforming conventional architectures) while still maintaining the efficiency benefits. An example slice attention architecture (e.g., used as part of an efficient transformer-based model) is discussed in more detail below with reference to FIG. 2.

In some aspects, local attention (also referred to as sliding window attention) limits the attention range to the vicinity of query locations. That is, key abstraction may be performed with the whole abstraction range, and the query abstraction may be performed using a location-dependent abstraction function:

$${{K}^{′}}_{l} = {ϕ}_{k , i}^{sliding} ( K ) = K ⊙ ( H ( i - j - \frac{w}{2} ) - H ( i - j + \frac{w}{2} ) )$$

where H is the Heaviside step function, w is the window length, i is a token index (e.g., denoting location dependency), and ⊙ is an element-wise product. In some aspects, therefore, the local attention may be defined using Equation 10 below:

$${y}_{l , i} = soft max ( {q}_{i} {{K}^{′}}_{l , i}^{T} ) {{V}^{′}}_{l , i} \qquad ( 10 )$$

In some aspects, for better computational efficiency, block-wise key abstraction can be defined as

$${{K}^{′}}_{l} = {ϕ}_{k , i}^{block} ( K ) = K ⊙ ( H ( {t}_{i} - j - \frac{w}{2} ) - H ( {t}_{i} - j + \frac{w}{2} ) )$$

for a block-wise attention where

$${t}_{i} = ( b - \frac{1}{2} ) w$$

for the block index b such that (b−1)w≤i<bw.

In some aspects, for the global attention, abstractive attention can be used with either positional abstractions (which may be loosely seen as having patch embeddings in vision transformers (ViTs)) and/or contextual abstractions.

In some aspects, the composite attention (with multi-scale and multi-range components) may be categorized according to how the two attentions are combined. For example one combination approach is to concatenate the abstractions of multi-scale keys and values for a single attention, such as using Equation 11 below.

$${y}_{g , i} = soft {max ( {{q}_{i} [ {{K}^{′}}_{l , i} , {{K}^{′}}_{g} ]}^{T} ) [ {{V}^{′}}_{l}^{T} , {{V}^{′}}_{g}^{T} ]}^{T} \qquad ( 11 )$$

In Equation 11, the subscript “g” denotes global attention or dependency. In some aspects, the multi-scale attention composition can be defined using separate attentions at different scales, where the outputs of each are combined or summed (possibly with some weighting coefficients), such as defined using Equation 12 below.

$${y}_{i} = {y}_{l , i} + {ψ}_{y} ( {y}_{g , i} ) \qquad ( 12 )$$

In this latter case (where the outputs are summed or otherwise combined), other non-attentive methods, such as kernel methods, may additionally or alternatively be used for the global attention.

In some aspects, the efficient transformer-based model architectures described herein may correspond to this latter case, where the local and global attentions are performed separately and their outputs are combined (e.g., summed) together. However, unlike other architectures, such as transformer-in-transformer (TNT), that have independent (parallel) paths for the local attention and the global attention and therefore prevent information exchange between patches, the efficient transformer-based model architectures described herein use a serial connection between multi-granular attentions to enable two-way information routing. Therefore, aspects of the present disclosure may be more suitable for modeling highly non-stationary data, such as natural language text data for which a locality assumption does not hold.

Attention with Input Slice Representations

Some aspects described herein implement so-called “slice attention” in transformer-based models (thus, the term composite slice vision transformer), which replaces the full softmax dot-product attention of at least some conventional transformer models. Beneficially, slice attention leverages both high-resolution attention in a limited range and abstracted attention to capture full-range interactions. Unlike previous approaches, in some aspects, the multi-scale multi-range attentions are configured using a serial connection that allows two-way information routing between the two attention mechanisms.

In a high-level description, the multi-scale multi-range attention of a composite slice vision transformer model corresponds to the combination of block-wise local window attention with patch-based attention. In some aspects, at the embedding layer, the composite slice vision transformer model converts the input tensor X∈ [symbol] ^{N×D} into a stack of slices S∈ [symbol] ^{N/L×L×D} by slicing the input tensor X based on a defined slicing operation and hyperparameter L (e.g., delineating the input tensor of tokens into a set of slices, into L×L sub-tensors). In some aspects, the slice hyperparameter(s) (e.g., a hyperparameter used to define the size of each slice) L may be selected or defined using a variety of criteria or techniques, and can generally include any value. For example, the slice hyperparameter may be selected (e.g., by a data scientist) to balance complexity and/or to improve model accuracy (e.g., using trial and error to test multiple slice sizes). In some aspects, two attentions with different granularities can then be performed sequentially in each direction, as discussed in more detail below with reference to FIG. 2.

In some aspects, the local attention is first performed across the tokens within each slice (e.g., described in more detail below with reference to section 215 in FIG. 2) while considering the number of slices as a batch. In some aspects, the local attention may be referred to as sliced local attention (e.g., a sliced local attention operation). In some aspects, the slice dimension N/L can be combined with the batch dimension and parallelized together so that

$${Y}_{l} = soft max ( {Q}_{l} {K}_{l}^{T} ) {V}_{l} \qquad ( 13 )$$

where Qₗ, Kₗ, and Vₗ are the queries, keys, and values (respectively) for the local attention obtained by applying learnable weights W_{q,1}, W_{k,1}, and W_{v,l} to stack or slice S. Next, in some aspects, the dimension of L in the local attention output can be collapsed using an abstraction function ϕ_{y} to get the slice embedding S′∈ [symbol] ^{N/L×D}. In some examples, a simple mean pooling ϕ_{y}(Yₛ)=Σₗ₌₀^{L-1}

$$\frac{{m}_{l} {Y}_{s , l}}{{\sum }_{l = 0}^{L - 1}} {m}_{l}$$

may be used where l is the token index along the length dimension and my is the attention mask value. In some aspects, normalization with the sum of a mask, instead of the slice length, in each slice helps avoid biases in the mean computation induced by masked tokens.

In some aspects, the second attention across the slice dimension (e.g., global attention) is then performed (e.g., described in more detail below with reference to section 245 in FIG. 2) to model full-range information routing in a reduced resolution according to:

$${Y}_{g} = softmax ( {Q}_{g} {K}_{g}^{T} ) {V}_{g} \qquad ( 14 )$$

where Q_{g}, K_{g}, and V_{g} are the queries, keys, and values (respectively) for the global attention obtained by applying W_{q,g}, W_{k,g}, and W_{v,g} to stack or slice S.

### Volatile Instant Multi-Scale Positional Embeddings

Because transformer-based models generally contain no recurrence and no convolution, in some aspects, some information about the relative or absolute position of the tokens in the sequence is injected in order for the model to make use of the order of the sequence. This may be referred to in some aspects as positional embedding (e.g., referred to in some aspects as Pₗ for local positional embeddings and P_{g} for global positional embeddings, and indicated by embedding functions 207 and 209, respectively, in FIG. 2). In some aspects, the positional encodings generally have the same dimensionality as the token embeddings (e.g., generated at embedding layer 202 in FIG. 2), so that the two can be directly summed.

In some aspects, because the lengths of both the global and local attentions are reduced (and may have different granularity) in the composite slice transformer model described herein, the full positional embeddings of the maximum input sequence length are not necessary (as compared to some conventional architectures). In some aspects, therefore, for the local attention, the positional embedding length may be limited to the attention range (e.g., to the slice size L). In addition, because the tokens from each slice are aggregated for the global attention, it may be more natural to have separate positional embeddings of length N/L at the scale of slice embeddings, rather than aggregating the full-resolution full-length positional embeddings.

In some aspects of the composite slice vision transformer models described herein, therefore, multi-scale positional embeddings Pₗ∈ [symbol] ^{L×d} and P_{g}∈ [symbol] ^{N/L×d} may be used (as depicted and described in more detail below with reference to embedding functions 207 and 209 FIG. 2). As discussed in more detail below, these multi-scale positional embeddings may be used in a different manner than in at least some conventional transformer models in multiple ways. First, rather than adding the positional embeddings to the stacked slices of token embeddings at the embedding layer, the positional embeddings may be applied at the corresponding attentions in each layer before the linear transformations. Second, the positional embeddings in the disclosed composite slice transformer models may be added only to the queries and keys (and not to the values). This can prevent the issue of the positional embeddings accumulating over all of the layers (and therefore undesirably dominating the contextual information at top layers), which potentially leads to performance degradation. Accordingly, in some aspects, for a composite slice vision transformer model, Equations 13 and 14 can be rewritten, respectively, as:

$${Y}_{l} = softmax ( ( {Q}_{l} + {P}_{l} ) {( {K}_{l} + {P}_{l} )}^{T} ) {V}_{l} \qquad ( 15 )$$

$${Y}_{g} = softmax ( ( {Q}_{g} + {P}_{g} ) {( {K}_{g} + {P}_{g} )}^{T} ) {V}_{g} \qquad ( 16 )$$

where Yₗ is the output from the local attention and Y_{g} is the output from the global attention.

### Complexity and Storage Improvements

In some aspects, as compared to the quadratic complexity O(N²) of conventional transformer models, the composite slice vision transformer models described herein have linear plus decimated quadratic complexity of

$$O ( N L ) + O ( \frac{{N}^{2}}{{L}^{2}} ) .$$

However, because the slice size L is typically less than the abstraction length M in other models with linear complexity, composite slice vision transformer models have comparable efficiency to other efficient transformer models for practical lengths of input sequences.

Another benefit of using the stacked slice representation in aspects described herein is the reduction in storage for the positional embeddings. As the lengths for attentions are L and N/L for local and global attentions, respectively, composite slice vision transformer models have fewer parameters (e.g.,

$$( L + \frac{N}{L} ) * D parameters$$

) than that of the conventional positional embeddings (e.g., N*D parameters in conventional transformer models).

### Example Slice Attention Layer Architecture for Composite Slice Vision Transformers

FIG. 2 depicts an example slice attention layer architecture 200 for composite slice vision transformers. In some aspects, the architecture 200 provides additional detail for a slice attention layer 206 of a composite slice vision transformer module. Specifically, in some aspects, the slice attention layer 206 may correspond to a slice attention layer of a transformer model.

In some aspects, a slice attention module (also referred to as an attention head in some aspects) that utilizes the slice architecture 200 may begin with a normalization layer, which normalizes the input data representation (e.g., using layer normalization) and then provides the normalized input data representation to the slice attention layer 206 (e.g., a layer of a neural network that implements or performs slice attention). In addition to the normalized input data representation, as illustrated, the slice attention layer 206 also receives as inputs a local positional embedding Pₗ and a global positional embedding P_{g}, which are generated by embedding functions 214 and 244, respectively, based on the output data representation from an embedding layer 202. The output of the slice attention layer 206 is generally an output data representation, in which local and global attentions have been applied.

In some aspects, within the transformer module, the input to the slice attention layer 206 (e.g., input 205) and the output of the slice attention layer 206 can be summed to generate input for another normalization layer, which may output a normalized output data representation that can be provided to a feed-forward network (FFN), which may be configured as a pointwise fully connected feed-forward network to have the attention output transformed nonlinearly as a new representation for the next layer. In some aspects, a skip connection can be used to add the input to the second normalization layer with the output of the feed-forward network in order to generate the final output data from the transformer-based model architecture.

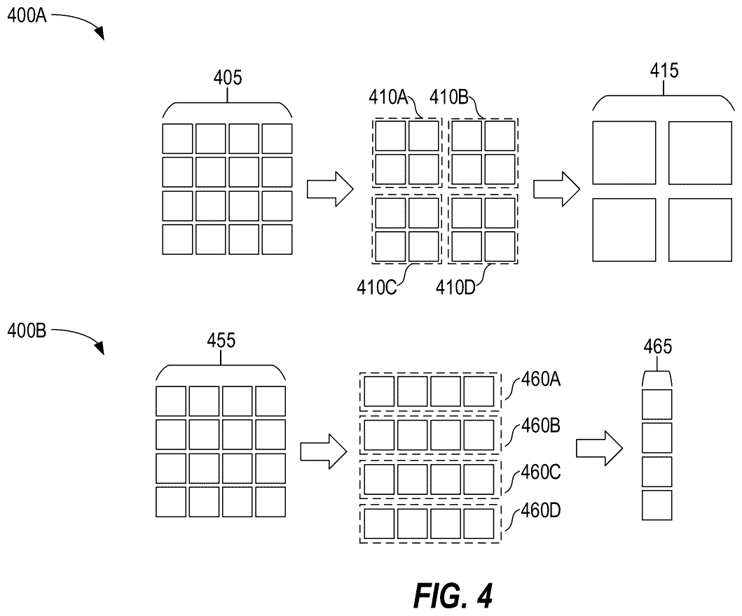

In the illustrated example of FIG. 2, the input 205 (of size [symbol] ^{N×D}), such as a tensor comprising image data (e.g., an image itself, or a feature map generated based on image data), is provided to a slicing layer 210, which slices the input 205 based on a slice hyperparameter L and/or slicing operation in order to generate slices of the input 205. Some non-limiting example slicing operations are discussed below in more detail with reference to FIG. 4.

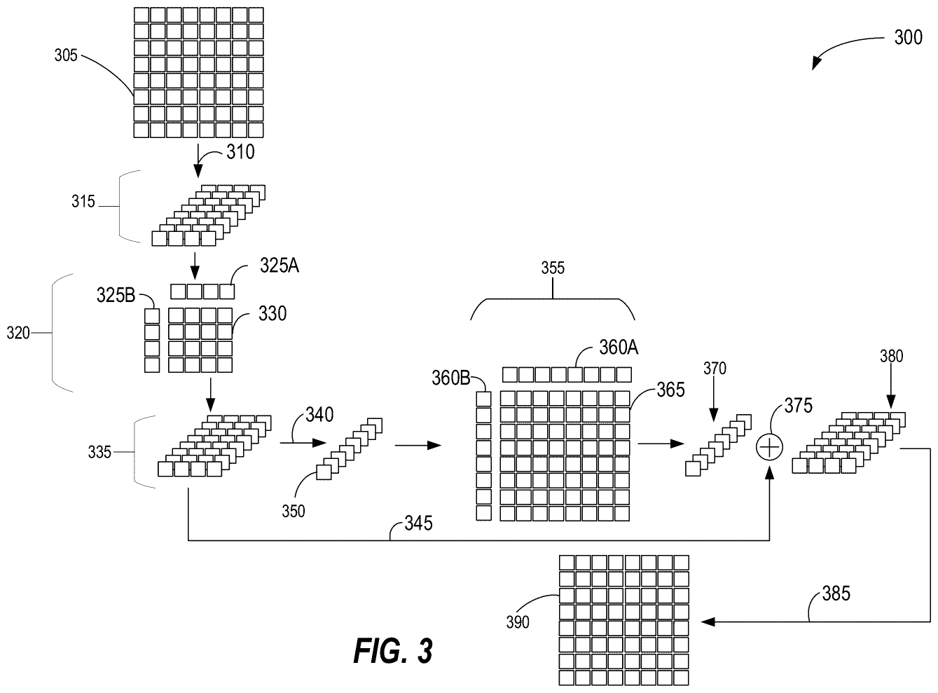

In some aspects, these slices can then be stacked (as discussed in more detail below with reference to FIG. 3) to generate a stacked slice input data representation of size [symbol] ^{N/L×L×D}. That is, the stacked slice input data representation may be formed by concatenating or stacking the slices to form an aggregate tensor.

In the illustrated example, a first, local (high- or full-resolution) attention is then performed on the input data at section 215 by initially adding local positional embeddings Pₗ (output by the embedding function 214 based on an embedding layer 212, which may generate embeddings based on input to the model that is used to generate the input 205) to the input data for generating the keys and queries, but not the input data for generating the values (as described above), at an adder 220. Then, a set of local attention parameters 225A-C (denoted W_{q,l}, W_{k,l}, and W_{v,l} in the illustrated example) are applied to the stacked slice data representation (augmented by the local positional embeddings, in the case of the keys and queries) to generate local queries Qₗ, local keys Kₗ, and local values Vₗ. In some aspects, the local attention parameters 225A-C (collectively, local attention parameters 225) may be referred to as a set of local weights, a set of local trained weights, a set of local learned weights, a first set of weights, a first set of trained weights, a first set of local weights, and the like. Matrix multiplications are then performed at a local attention element 230 to generate local attention output data of size [symbol] ^{N/L×L×D}.

That is, the local attention mechanism (indicated by section 215) includes the addition of the local positional embeddings at the adder 220, application of the local attention parameters 225 (also referred to as weights), and finally use of the local attention element 230 (e.g., to compute the local attention, such as by using Equation 15 above). Generally, the illustrated example depicts performing the local attention (in the section 215) in a specific arrangement (e.g., including use of positional embeddings to a subset of the matrices). However, other configurations may be used in some aspects (e.g., the positional embeddings may be added to the value matrix as well as the key and query matrices, positional embeddings may be excluded or unused for one or more of the matrices, and the like).

In some aspects, as discussed above, the local attention parameters 225 are trainable (e.g., learned) parameters. In some aspects described herein, the first (local) attention is referred to as high-resolution. As used herein, this local attention may be referred to as “high” resolution to indicate that the local attention uses or has a higher resolution than that of the subsequent (global) attention (e.g., up to and including full-resolution). That is, in some aspects, the global attention may be performed in a reduced resolution (e.g., by abstracting or aggregating one or more tokens or elements in the sequence into a sequence with fewer elements, such as by grouping multiple elements into a single element, and performing global attention on this relatively smaller sequence, as compared to the length of the original sequence). This can improve efficiency and computational expense. In some aspects, the local attention may be performed in a relatively higher resolution (e.g., with less abstraction, such as by aggregating fewer elements together, and/or by using no abstraction, such as by evaluating the slices at full (original) resolution).

In the illustrated example, the local attention output data (output by the local attention element 230) is then processed by a slice embedding element 235 to resize the data to [symbol] ^{N/L×1×D}. As described above, the slice embedding element 235 may implement an abstraction function, such as mean pooling within each slice in some examples, to generate the slice embeddings. As discussed below, this abstraction (e.g., mean pooling within each slice) allows the global attention to operate more efficiently or with reduced expense, as the global attention uses a relatively lower resolution (as compared to operating on the original input tokens).

As illustrated, a second, global (and reduced- or low-resolution) attention is performed on the slice embeddings at the section 245 by initially adding global positional embeddings P_{g} (output by the embedding function 244 based on the embedding layer 212) to the local attention output data for generating the keys and queries, but not for the input used to generate the values, at an adder 250. Note that unlike the local positional embeddings, Pₗ, the global positional embeddings P_{g} are sized [symbol] ^{N/L×1×D} consistent with the size of the slice embeddings. In some aspects, the global attention may be referred to as a global attention operation.

As illustrated, a set of global attention parameters 255A-C (denoted W_{q,g}, W_{k,g}, and W_{v,g} in the illustrated example) are applied to the slice embeddings (augmented by the global positional embeddings for the keys and queries) to generate global queries Q_{g}, global keys K_{g}, and global values V_{g}. In some aspects, the global attention parameters 255A-C (collectively, global attention parameters 255) may be referred to as a set of global weights, a set of global trained weights, a set of global learned weights, a second set of weights, a second set of trained weights, a second set of local weights, and the like. Matrix multiplications are then performed at a global attention element 260, as described above, to generate global attention output data of size [symbol] ^{N/L×1×D}.

That is, the global attention mechanism (indicated by the section 245) includes the addition of the global positional embeddings at the adder 250, application of the global attention parameters 255 (also referred to as weights), and finally use of the global attention element 260 (e.g., to compute the global attention, such as by using Equation 16 above).

In some aspects, as discussed above, the global attention parameters 255 are trainable (e.g., learned) parameters. In some aspects described herein, the second (global) attention is referred to as low-resolution and/or reduced resolution. As used herein, this global attention may be referred to as “low” or “reduced” resolution in some aspects to indicate that the global attention uses or has a lower resolution than that of the first (local) attention (e.g., that the input to global attention may be abstracted or otherwise reduced to a smaller number of tokens or elements, as compared to the original input sequence). In some aspects, rather than reduced resolution, the global attention may similarly operate at full (or higher) resolution, in a similar manner to the local attention.

In the illustrated example, the output from the global attention element 260 is then broadcast added to the local attention output (output by the local attention element 230) by way of a skip connection 240 and an adder 265. Here, the adder 265 performs a broadcast addition owing to the difference in size between the output from the global attention element 260 ( [symbol] ^{N/L×1×D}) and the local attention output ( [symbol] ^{N/L×L×D}).

As depicted, the output of the adder 265 is then provided to a de-slicing layer 270, which transforms the output from a stacked slice shape to a tensor of shape [symbol] ^{N×D}, matching the original input 205 to the slicing layer 210.

Finally, a linear layer 275 performs a linear transformation to generate stacked slice output data 280.

Although the illustrated example depicts a single local attention element 230, in some aspects, the architecture 200 may include multiple local attentions, as discussed below in more detail.

FIG. 3 depicts an example data flow 300 for slice attention in composite slice vision transformers, as may be implemented by the slice attention layer architecture 200 described with respect to FIG. 2.

As depicted, an input tensor 305 (e.g., the input 205 of FIG. 2) is sliced via an operation 310 (e.g., based on a slice operation or hyperparameter using the slicing layer 210 of FIG. 2) to generate a stacked slice representation 315. The stacked slice representation 315 is then processed by all or a part of a slice attention layer (e.g., a local attention element 320 (e.g., the section 215 of FIG. 2)), which may have complexity O(N/LL²), to generate a local attention output 335. As discussed above, the local attention element 320 may be referred to as “high-resolution” in some aspects. In the illustrated example and as discussed above, the local attention element 320 generally includes application of trained or learned weights (e.g., a key weight and/or query weight with values learned during training of the model) to each slice of the stacked slice representation 315 (thereby generating a query matrix 325B (e.g., the query matrix 104 of FIG. 1) and a key matrix 325A (e.g., the key matrix 106 of FIG. 1). These matrices 325A, 325B are then combined (e.g., using matrix multiplication) to generate an intermediate matrix 330 (e.g., the intermediate matrix 108 of FIG. 1), which is then combined (e.g., using matrix multiplication) with the value matrix (e.g., the value matrix 110 of FIG. 1, which is similarly generated using trained or learned weights, such as value weights having values learned during training of the model) to generate an output local attention for each slice. Although the illustrated example depicts applying the local attention for a single slice, in aspects, the local attention element 320 can operate on the entire stacked slice representation 315. Additionally, though generating and use of one or more weights to generate key, query, and value matrices are discussed above, in some aspects, the local attention may generally include a wide variety of operations to generate the local attention output.

As illustrated, the local attention output 335 is then processed by an abstraction function 340 (e.g., the slice embedding element 235 of FIG. 2) to generate a set of slice embeddings 350. The slice embeddings 350 are then processed by a global attention element 355 (e.g., the section 245 of FIG. 2), which may have complexity O(N²/L²) to generate a global attention output 370. As discussed above, the global attention element 355 may be referred to as “reduced-resolution” in some aspects, due to this abstraction function 340. That is, because the global attention may be performed on the slice embeddings 350 (generated by abstracting the abstraction function 340), rather than directly on the input tokens, the global attention may be considered relatively lower resolution, as compared to the local attention. As discussed above, the global attention element 355 may generally apply learned parameters (e.g., key weight and/or query weight) to generate a query matrix 360B and/or a key matrix 360A, which are combined to create an intermediate matrix 365, which is then combined with the value matrix to yield the global attention output 370.

As illustrated, the global attention output 370 is then broadcast added via an adder 375 (e.g., the adder 265 of FIG. 2) to the local attention output 335 (provided via a skip connection 345) to generate stacked slice output data 380. Finally, the stacked slice output data 380 is de-sliced using an operation 385 (e.g., using the de-slicing layer 270 of FIG. 2) to provide an output tensor 390 (e.g., the slice output data 280 of FIG. 2).

### Example Slicing Operations for Composite Slice Vision Transformers

FIG. 4 depicts example slicing operations 400A and 400B (collectively, slicing operations 400) to slice input tensors for composite slice vision transformers. In some aspects, the slicing operations 400 may be performed by a slicing layer, such as the slicing layer 210 of FIG. 2.

Generally, both of the slicing operations 400 may be used to generate a set of slices based on an input tensor (e.g., an input image or other tensor comprising image data). In some aspects, the slicing operation 400A may be referred to as regional slicing, while the slicing operation 400B may be referred to as axial slicing. As discussed above, the image data may generally include direct image data (e.g., red, green, and blue values for one or more pixels) and/or data generated based on such direct image data (e.g., a feature map generated based on an image). Although two-dimensional input tensors 405 and 455 are depicted for conceptual clarity, in some aspects, the input tensors may be three-dimensional (or may have more than three dimensions). For example, the input tensors 405 may have dimensionality (H×W×C), where H and W are spatial dimensions (e.g., height and width, respectively) and C is a depth dimension (e.g., the number of channels, such as three for red, green, and blue).

In the illustrated example, the input tensor 405 comprising a plurality of elements can be sliced using the regional slicing operation 400A to generate a set of slices 410A-410D (collectively, slices 410). In the illustrated example, the input tensor 405 includes sixteen elements (arranged in four rows and four columns). Additionally, in the illustrated example, the input tensor 405 has a depth of one. As illustrated, the regional slicing operation 400A generally comprises generating the slices 410 such that each slice includes a set of elements that are relatively near each other in the input tensor 405. For example, in the illustrated example, the regional slicing operation 400A generates the slices 410, each having four elements that neighbor each other in the input tensor 405. That is, the regional slicing operation 400A slices the input tensor 405 based on two-dimensional windows of a defined size (e.g., based on one or more slicing hyperparameters, such as L), such that neighboring elements will be more likely to remain in the same slice. In some aspects, this regional slicing can improve performance in vision tasks, as contextual information can be retained across both rows and columns.

In the illustrated example, these slices 410 are processed using one or more local attention elements, as discussed above and in more detail below. That is, each slice has a local attention operation applied to generate corresponding local attention features or data. Additionally, in the illustrated example, each slice (or the local attention output for each slice) is aggregated to enable higher-level global attention to be applied, as illustrated by tensor 415. That is, while local attention is applied on a per-element basis (e.g., based on four elements in each slice), the resulting output for each slice is then aggregated (e.g., pooled using a slice embedding element, such as the slice embedding element 235 of FIG. 2), resulting in relatively fewer elements in the tensor 415. Global attention can then be applied on this tensor 415, allowing for capturing of contextual information across the entire input.

Additionally, in the illustrated example, the input tensor 455 comprising a plurality of elements can be sliced using the axial slicing operation 400B to generate a set of slices 460A-460D (collectively, slices 460). In the illustrated example, the input tensor 455 includes sixteen elements (arranged in four rows and four columns). Additionally, in the illustrated example, the input tensor 455 has a depth of one. As illustrated, the axial slicing operation 400B generally comprises generating the slices 460 such that each slice includes a set of elements that are contained within a single row of the input tensor 455. For example, in the illustrated example, the axial slicing operation 400B generates the slices 460, each having four elements that are from a corresponding row in the input tensor 405.

Although the illustrated example depicts row-wise slicing, in some aspects, the axial slicing operation 400B may additionally or alternatively comprise vertical (column-wise) slicing (e.g., where each slice includes the elements of a corresponding column). Additionally, though not included in the illustrated example, in some aspects the axial slicing operation 400B may generate slices that each have less than an entire row (or column) of elements. For example, based on one or more slicing hyperparameters, such as L, the axial slicing operation 400B may divide each row (or column) into multiple slices (e.g., each having a maximum length of L). Additionally, in some aspects, the axial slicing operation 400B may be used to generate both row-wise and column-wise slices. In some aspects, local and/or global attention may be applied separately on each set of slices, and the resulting attention outputs from each may thereafter be combined to form aggregate or overall attention output based on the input tensor 455.

In the illustrated example, these slices 460 are processed using one or more local attention elements, as discussed above and in more detail below. That is, each slice has a local attention operation applied to generate corresponding local attention features or data. Additionally, in the illustrated example, each slice (or the local attention output for each slice) is aggregated to enable higher-level global attention to be applied, as illustrated by tensor 465. That is, while local attention is applied on a per-element basis (e.g., based on four elements in each slice), the resulting output for each slice is then aggregated (e.g., pooled using a slice embedding element, such as the slice embedding element 235 of FIG. 2), resulting in relatively fewer elements in the tensor 465. Global attention can then be applied on this tensor 465, allowing for capturing of contextual information across the entire input.

The illustrated example depicts two slicing operations 400 for conceptual clarity. However, other techniques or methodologies to slice the input tensors may be used depending on the implementation. For example, the slicing operation may include generation of non-square regional slices, slicing across depth as well as across spatial dimensions, and the like.

### Example Workflow for Saliency Evaluations to Enable Dynamic Attention

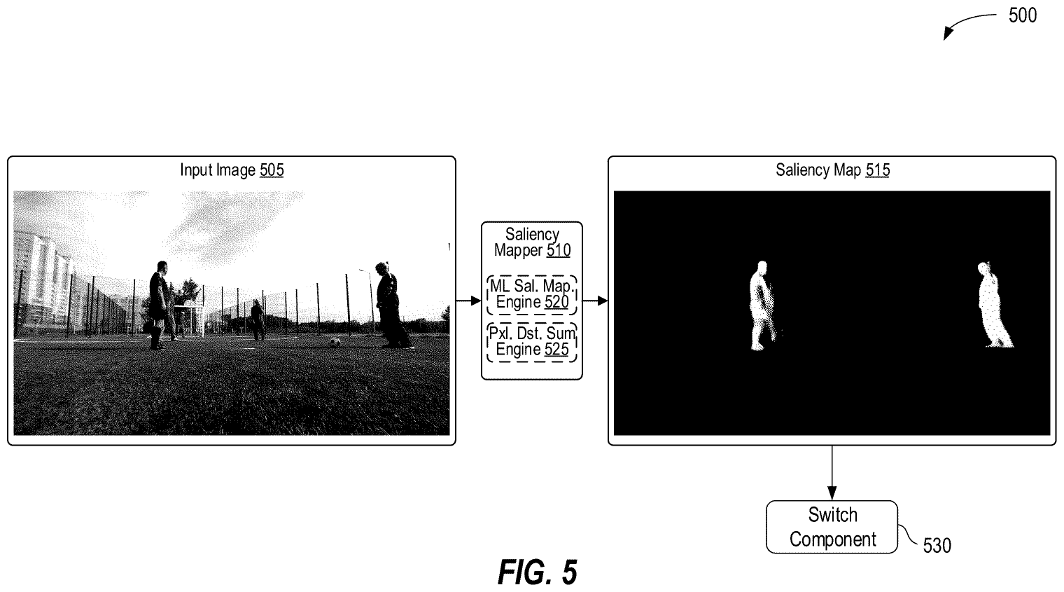

FIG. 5 depicts an example workflow 500 for saliency evaluations to enable dynamic attention.

In some aspects of the present disclosure, a dynamic attention approach may be used based on the characteristics of the input data. For example, in some aspects (as discussed in more detail below), local attention may be applied multiple times (e.g., at different resolutions or scales), followed by a global attention. In some aspects, the number of local attention operations to be used may be selected or determined based on characteristics of the input data, such as the saliency map of the input, the resolution of the input, and the like.

In the illustrated example, a saliency map 515 is generated based on an input image 505 using a saliency mapper 510. The input image 505 of FIG. 5 depicts five people playing soccer on a field surrounded by fences, with buildings in the background. Two of the five people are depicted in the foreground of the input image 505, in front of the other three people in the input image 505. The two people in the foreground of the input image 505 are larger and more prominent in the input image 505 than the other three people in the input image 505.

In imaging, a saliency value of a pixel in an image refers to how unique the pixel is compared to other pixels of the image. In some cases, important visual elements of an image, such as depictions of people or animals, can have higher saliency values than background elements of an image. A saliency map maps a saliency value to every pixel in an image. A saliency map can be depicted visually, for example by representing high saliency values (e.g., above a saliency value threshold) in whites and light grey shades in the saliency map and by representing low saliency values (e.g., below a saliency value threshold) in blacks and dark grey shades in the saliency map, or vice versa.

The saliency map 515 generated by the saliency mapper 510 identifies pixels of the input image 505 that have a high saliency value with white or light grey pixels in the saliency map 515. The saliency map 515 generated by the saliency mapper 510 identifies pixels of the input image 505 that have a low saliency value with black or dark grey pixels in the saliency map 515. The pixels in the input image 505 that depict the two people in the foreground of the input image 505, and a part of a third person who is depicted just behind one of the two people in the foreground of the input image 505, have high saliency values (e.g., above a saliency value threshold) according to the saliency map 515, and are therefore represented in whites and light grey shades in the saliency map 515. The remaining pixels of the input image 505 (e.g., depicting the grass, the fences, the buildings, and the remaining three people) have low saliency values (e.g., below a saliency value threshold) according to the saliency map 515, and are therefore represented in blacks and dark grey shades in the saliency map 515.

The saliency mapper 510 can include a machine learning (ML) saliency mapper engine 520, a pixel distance sum engine 525, or both. The pixel distance sum engine 525 may calculate the respective saliency value for each pixel of the input image 505 to be (or to be based on) a sum of a plurality of pixel distances between that pixel and other pixels of the input image 505. For instance, a saliency value for a pixel k of the input image 505 can be determined by the pixel distance sum engine 525 using the formula saliency (k)=Σᵢ₌₁^{N}|Iₖ−Iᵢ|, where Iᵢ is a pixel value for a pixel i, Iₖ is a pixel value for the pixel k, and N is the total number of pixels in the input image 505. The pixel values Iᵢ and Iₖ can be, for instance, numerical values lying in a range between 0 (black) and 555 (white). The pixel values Iᵢ and Iₖ can include multiple sets of numerical values each lying in a range between 0 and 555, for instance with a set each corresponding to different color channels (e.g., red, green, blue). The pixel values Iᵢ and Iₖ can be, for instance, hexadecimal color codes (e.g., HTML color codes) lying in a range between 000000 (black) and FFFFFF (white). The value of |Iₖ−Iᵢ| can represent a distance (e.g., Euclidean distance, Manhattan distance, Mahalanobis distance, Minkowski distance, or a combination thereof) between the set of one or more pixel values corresponding to the pixel k and the set of one or more pixel values corresponding to the pixel i. In some cases, the distance may be a distance in a multi-dimensional color space, for instance with different color channels (e.g., red, green, blue) changing along different axes in the multi-dimensional color space, with hue and luminosity changing along different axes in the multi-dimensional color space, or a combination thereof. In some examples, a multiplier m may be introduced into the saliency formula, making the formula saliency(k)=Σᵢ₌₁^{N}m·|Iₖ−Iᵢ|. In some examples, multiple pixels in the input image 505 may have identical pixel values, in which case a modified saliency formula may be used: saliency(k)=ΣFₙ·|Iₖ−Iₙ|, where Fₙ represents a frequency of how often the pixel value Iₙ appears in different pixels n in the input image 505. The saliency map 515 is an example of a saliency map that can be generated by pixel distance sum engine 525. The pixel distance sum engine 525 may be referred to as the pixel distance sum system.

The saliency mapper 510 can include a machine learning (ML) saliency mapper engine 520. The ML saliency mapper engine 520 can include one or more trained machine learning (ML) models, such as one or more trained neural networks (NNs), one or more trained support vector machines (SVMs), one or more trained random forests, or a combination thereof. The ML saliency mapper engine 520 can provide the input image 505, and/or metadata associated with the input image 505, to the one or more trained ML models as an input to the one or more trained ML models. The ML saliency mapper engine 520 can thus apply the one or more trained ML models to the input image 505 and/or to the metadata associated with the input image 505. The one or more trained ML models of the ML saliency mapper engine 520 may output the saliency map 515, or information that may be used by the saliency mapper 510 to generate the saliency map 515 (e.g., only positions of pixels having a saliency value above a threshold, or only positions of pixels having a saliency value below a threshold). In some examples, the one or more trained ML models of the ML saliency mapper engine 520 are trained using supervised learning, unsupervised learning, deep learning, or a combination thereof. In some examples, the one or more trained ML models of the ML saliency mapper engine 520 are trained using training data that includes images and corresponding saliency maps that were generated using the pixel distance sum engine 525, or a similar system.

In some aspects, the system may identify clusters of pixels having relatively high saliency values (e.g., above a threshold), and these clusters may be classified or recognized as contextual objects or foreground objects. For example, to identify clusters, the system may identify a set of pixels satisfying the saliency criteria (e.g., with sufficiently high salience) that are contiguous or adjacent to each other (or within a defined distance from each other). In some aspects, the system may apply a clustering algorithm (e.g., k-means clustering) to cluster the salient pixels (e.g., pixels having sufficiently high salience values) into a set of one or more clusters, where each cluster corresponds to a contextual object.

In some aspects, the semantic complexity of an image or input tensor may refer to the number of contextual objects (e.g., clusters or groups of pixels having high salience values, where the groups are separated by at least a threshold distance or are otherwise distinguishable, such as due to a set of non-salient pixels between the clusters). For example, an input having several contextual objects may be more semantically complex, as compared to an input having few (or no) contextual objects. As another example, the semantic complexity of the image or input may refer to the number or percentage of pixels or elements that have a saliency score above a threshold (where more salient pixels correspond to higher semantic complexity). As another example, the semantic complexity may correspond to the average salience of the image (e.g., the average of the scores for each pixel or element). Generally, the semantic complexity may be defined or determined using any suitable technique.

In the illustrated example, the saliency map 515 (or the contextual objects detected therein) is provided to a switch component 530. The switch component 530 may evaluate the saliency map 515, the contextual objects detected therein, and/or other information to determine or select the particular attention scheme to use to process the input image 505. For example, in some aspects, the switch component 530 may determine the number of local attentions to apply prior to applying the global attention, as discussed in more detail below.

In some aspects, in addition to or instead of evaluating the saliency map 515, the switch component 530 may evaluate other characteristics of the input, such as the resolution of the input image 505 (e.g., the height and width, in number of pixels). In some aspects, for images having higher resolution and/or a higher number of contextual (e.g., foreground) objects, the switch component 530 may determine to use more local attention operations, as compared to an image having lower resolution and/or fewer foreground objects, as discussed in more detail below. As another example, the switch component 530 may evaluate characteristics of the output of the model, such as the target resolution (e.g., the resolution at which the output will be displayed) and/or the resolution of the display(s) that will be used to display the model output. In some aspects, for outputs having higher resolution (e.g., larger monitors or displays with more pixels), the switch component 530 may determine to use more local attention operations, as compared to lower-resolution outputs.

Example Architecture for Composite Slice Vision Transformers with Dynamic Attention

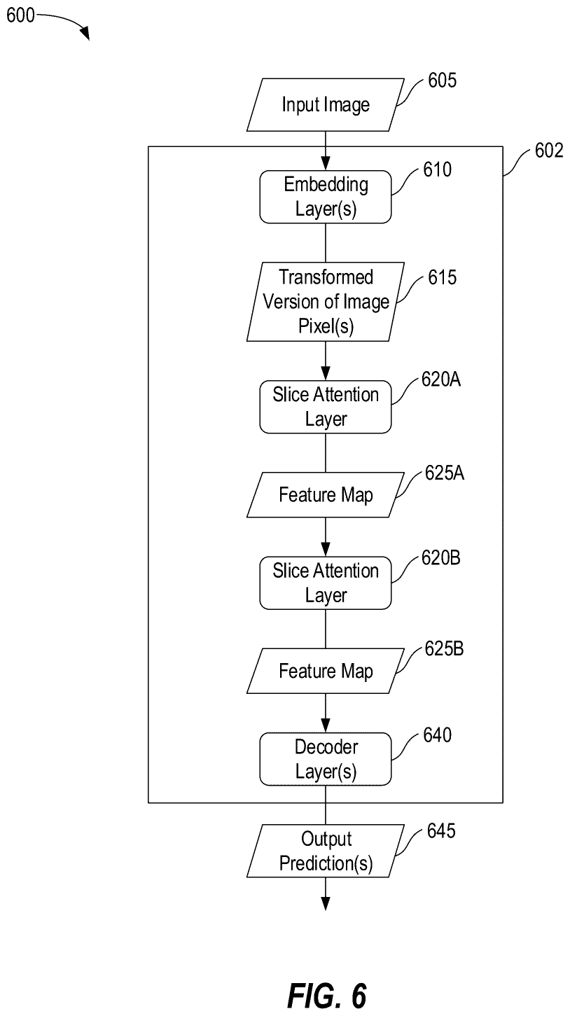

FIG. 6 depicts an example transformer architecture 600 for composite slice vision with dynamic attention.

In the illustrated example, an input image 605 is accessed by a machine learning model 602 to generate a set of one or more output prediction(s) 645. As used herein, “accessing” data generally includes receiving, retrieving, collecting, generating, determining, measuring, requesting, obtaining, or otherwise gaining access to the data. The input image 605 may generally correspond to image data (e.g., captured via one or more imaging sensors, such as cameras) and provided as input to the machine learning model 602. For example, the input image 605 may be captured using one or more cameras on a vehicle (e.g., an autonomous or semi-autonomous vehicle, or a vehicle that provides driver or pilot assistance such as impact warning or avoidance, lane keeping, and the like), such as a car, truck, or aircraft. That is, the architecture 600 may be implemented by a vehicle. As another example, the input image 605 may be captured by one or more cameras associated with an extended reality (XR) system (e.g., a virtual reality (VR), augmented reality (VR), and/or mixed reality (MR) headset). That is, the architecture 600 may be implemented by an XR system or device

The particular content and format of output prediction(s) 645 may vary depending on the particular implementation and task. For example, the output predictions 645 may include one or more semantic segmentation maps for the input image 605 (e.g., indicating the semantic meaning of each pixel in the input image 605, such as identifying what each pixel depicts), one or more depth maps (e.g., indicating the depth of each pixel based on the predicted distances between the object depicted by each pixel and the camera or other imaging sensor), and the like. In some aspects, the output predictions 645 may additionally or alternatively include data such as classifications or object recognitions (e.g., identifying the object(s) depicted in the input image 605). Generally, the output prediction(s) 645 may correspond to any computer vision task.

In the illustrated example, the machine learning model 602 comprises a transformer architecture that includes a set of operations, including one or more embedding layer(s) 610, one or more slice attention layer(s) 620, and one or more decoder layer(s) 640. Specifically, as illustrated, the input image 605 is processed using a set of embedding layer(s) 610 to generate transformed version of image pixels 615 (e.g., a tensor where each element corresponds to a transformed version of one or more pixels in the input image 605). Generally, the operations performed by the embedding layer(s) 610 may vary depending on the particular implementation.

For example, in some aspects, the embedding layer(s) 610 may perform various operations such as convolutional processing and/or downsampling (e.g., to perform patch embedding) to generate the transformed version of image pixels 615. As illustrated, the transformed version of image pixels 615 (sometimes referred to as a feature map or as a “tensor”, such as an output tensor from the embedding layer(s) 610 and/or an input tensor to the slice attention layer 620A) is processed by the slice attention layer 620A to generate a feature map 625A (sometimes referred to as “transformer output,” an “output tensor” of the slice attention layer 620A, or as another transformed set of image pixels). In some aspects, the slice attention layer 620A corresponds to the slice attention layer 206 of FIG. 2 (e.g., where the transformed version of image pixels 615 correspond to the input 205 and the feature map 625A corresponds to the output data 280).

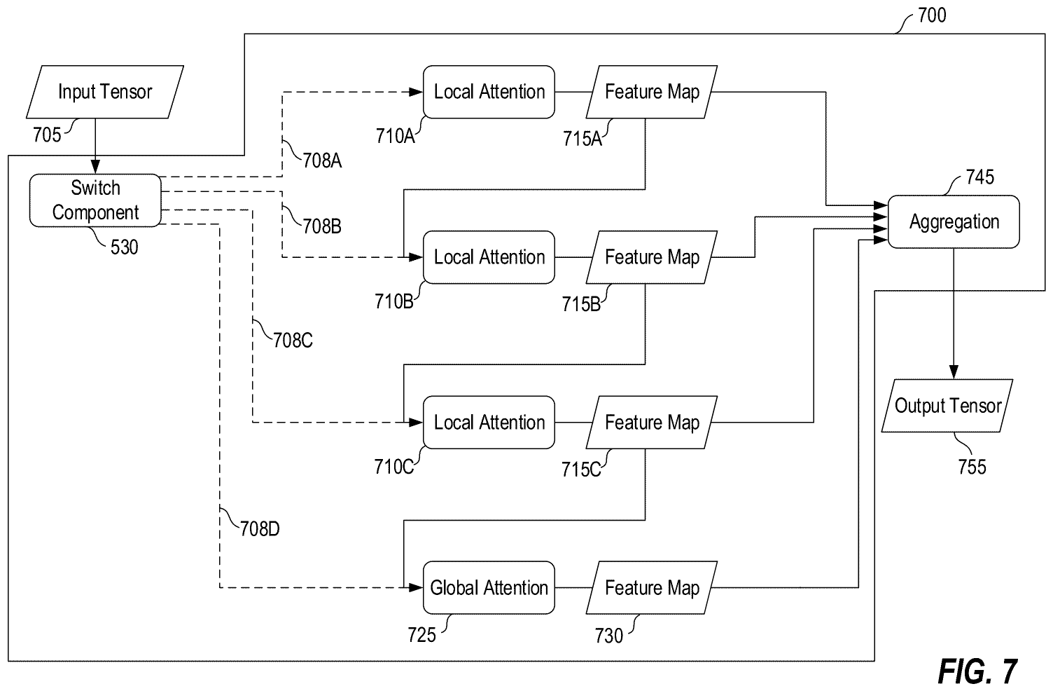

In some aspects, the slice attention layer 620A uses a multi-scale and/or multi-context architecture, as discussed below in more detail with respect to FIGS. 7-11, to generate attention output (e.g., the feature map 625A). That is, each slice attention layer 620 may include zero or more local attention operations followed by one or more global attention operations, as discussed below, to generate the output feature map. As illustrated, the feature map 625 may then be processed by a second slice attention layer 620B to generate a second feature map 625B (sometimes referred to as “transformer output,” an “output tensor” of the slice attention layer 620A, or as another transformed set of image pixels). In some aspects, as discussed above, the slice attention layer 620B may correspond to or be a copy of the slice attention layer 620A, or may be trained separately and/or may use a different architecture (such as one of the architectures discussed below with reference to FIGS. 7-11).

Although two slice attention layers 620 are depicted for conceptual clarity, there may be any number of slice attention layers 620 in the machine learning model 602 in some aspects. For example, in some aspects, the machine learning model 602 may include four or more slice attention layers 620, where each slice attention layer (after the first) receives input from the prior slice attention layer and provides output to the subsequent slice attention layer (other than the last).

In the illustrated example, the feature map 625B is processed using a set of one or more decoder layer(s) 640 to generate the output prediction(s) 645. Generally, the decoder layer(s) 640 may correspond to any operations or components (e.g., trained machine learning model components) that transform the feature map 625B from the latent space to the prediction space. For example, for a classification task, the decoder layer(s) 640 may include a single layer that classifies the feature map 625B (e.g., based on the depicted object(s)). For dense prediction tasks, such as depth estimation, the decoder layer(s) 640 may include one or more components such as transformer layers, convolution layers, and the like to generate a two-dimensional output (e.g., indicating the predicted depth for each pixel).

Although the illustrated example depicts the decoder layer(s) 640 as part of the machine learning model 602, in some aspects, the decoder layer(s) 640 may be implemented as a discrete component. For example, the feature map 625B output by the final slice attention layer 620B may be provided (e.g., transmitted) to a separate decoder component, which may use the decoder layers 640 to generate the output predictions 645. That is, the feature map 625B may be generated by a first device (e.g., a system comprising a transmitter component, sometimes referred to as a transmitter device) and the feature map 625B may be transmitted to a second device (e.g., a receiver or decoder device or system) that generates the output and/or uses the output for various processes.

Although not included in the illustrated example, in some aspects, the output predictions 645 may then be consumed for any downstream process, depending on the particular implementation. For example, in a self-driving implementation, the output prediction(s) 645 may be consumed by the navigation system(s), object avoidance system(s), lane following system(s), and the like. As another example, for XR implementations, the output predictions 645 may be output via one or more displays. For example, the output predictions 645 may be overlaid or superimposed on the input image 605 or otherwise displayed over a view of the scene, allowing the predictions (e.g., depths, segmentations, classifications, and the like) to be displayed to the user in the context of the input image 605.

Generally, the machine learning model 602 may use any number and variety of decoder layers 640 (which may be combined or distributed across any number of systems) to perform efficient composite slice vision transformer operations, as discussed above and in more detail below.

Example Architecture for Composite Slice Vision Transformers with Dynamic Attention

FIG. 7 depicts an example architecture 700 for composite slice vision transformers with dynamic attention.

In some aspects, the architecture 700 corresponds to or provides more detail for a slice attention layer, such as the slice attention layer 206 of FIG. 2 and/or one of the slice attention layers 620 of FIG. 6. That is, local attention blocks 710A-C (collectively, local attention blocks 710) may each correspond to the local attention discussed above with reference to the section 215 of FIG. 2, and a global attention block 725 may correspond to the global attention discussed above with reference to the section 245 of FIG. 2. Although a single slice attention layer is depicted by the architecture 700, as discussed above, the architecture 700 may act as one of multiple slice attention layers in a transformer-based machine learning model (e.g., multiple such attention layers may be used in sequence to process input data).

In the illustrated example, an input tensor 705 is accessed. For example, the input tensor 705 may be received as input to a machine learning model (e.g., if the architecture 700 corresponds to the first layer), or may be received as the output of a prior layer in the model. In some aspects, as discussed above, the input tensor 705 comprises image data. That is, the input tensor 705 may be an image (e.g., as input to the model) and/or may include data generated based on an input image (e.g., an attention output or other feature map or tensor generated by one or more prior layers based on an input image). In some aspects, the input tensor 705 corresponds to a transformed version of image pixels (e.g., the transformed version the image pixels 615 of FIG. 6 and/or a feature map 625 of FIG. 6).

In the illustrated example, the input tensor 705 is first processed by the switch component 530, discussed above. In the illustrated example, the switch component 530 evaluates one or more characteristics or features of the input tensor 705 to determine how many levels of attention should be applied. For example, as illustrated, the switch component 530 may provide the input tensor 705 as input to the local attention block 710A via link 708A (causing three local attentions to be performed, as discussed in more detail below), to the local attention block 710B via the link 708B (causing two local attentions to be performed, as discussed in more detail below), to the local attention block 710C via the link 708C (causing a single local attention to be performed, as discussed in more detail below), or to the global attention block 725 via the link 708D (causing zero local attentions to be performed, as discussed in more detail below).

In some aspects, as discussed above, the switch component 530 may evaluate information such as a saliency map (e.g., the saliency map 515 of FIG. 5), the resolution (e.g., dimensionality) of the input tensor 705, the target output resolution, the resolution of the display(s) that will be used to display the output, and the like. For example, in some aspects, as discussed above, the switch component 530 may compare the size (e.g., the spatial resolution) of the input tensor 705 (e.g., the number of pixels or elements in the height and width dimensions) to one or more thresholds. As another example, in some aspects, as discussed above, the switch component 530 may compare the number of detected contextual objects (e.g., foreground objects), as indicated in the saliency map for the input tensor 705, to one or more thresholds.

As another example, in some aspects, the switch component 530 may compare the intended or target resolution of the model output (e.g., the output prediction(s) 645 of FIG. 6) and/or the resolution of the display(s) that will be used to display the output(s) to one or more thresholds. For example, the switch component 530 may determine the resolution or size of the display(s) that will be used to output the model predictions (e.g., the XR display, the in-car display, and the like). In some aspects, the number of local attention operations selected and/or used by the switch component 530 may be directly proportional to the (spatial) size or resolution of the input tensor, the (spatial) size or resolution of the output of the machine learning model and/or the resolution of the target display(s), and/or the number of contextual objects detected in the input.

The switch component 530 may then select the attention scheme (e.g., the number of local attentions, such as ranging from zero to three) to apply based on these comparisons. Although the illustrated example depicts three local attention blocks 710, in some aspects, the architecture 700 may include any number of (optional) local attention blocks.

As one example, consider the following set of thresholds or rules that determine how to map the resolution and number of contextual objects of the input tensor 705 to a corresponding level of the architecture 700. Although specific thresholds and examples are given for conceptual clarity, it is to be understood that the particular thresholds or rules used to define the mapping may vary depending on the particular implementation.

In some aspects, the switch component 530 may evaluate the spatial resolution of the input tensor 705 against three resolution thresholds: a first threshold for high resolution data (e.g., equal to or greater than (M×N) number of elements in the spatial dimensions), a second threshold for middle resolution data (e.g., equal to or greater than (O×P) number of elements in the spatial dimensions, where O and/or P are less than M and/or N, respectively), and a third threshold for low resolution data (e.g., equal to or greater than (Q×R) number of elements in the spatial dimensions, where Q and/or R are less than O and/or P, respectively). For example, the first resolution threshold may correspond to 4K data (e.g., having spatial dimensionality of at least 4,096 elements in width and 2,160 elements in height), the second resolution threshold may correspond to 2K data (e.g., having spatial dimensionality of at least 2,048 elements in width and 1,080 elements in height), and the third resolution threshold may correspond to 1K data (e.g., having spatial dimensionality of at least 1,024 elements in width and 540 elements in height).

In some aspects, the switch component 530 may similarly evaluate the number of contextual objects in the input tensor 705 against three complexity thresholds: a first threshold for complex inputs (e.g., having at least S contextual objects), a second threshold for middle complexity (e.g., having at least T contextual objects, where T is less than S), and a third threshold for low complexity data (e.g., having at least U contextual objects, where U is less than T). For example, the first complexity threshold may correspond to input having at least three contextual objects, the second complexity threshold may correspond to input having at least two contextual objects, and the third complexity threshold may correspond to input having at least one contextual object.

In some aspects, the switch component 530 may evaluate both the spatial resolution of the input tensor 705 as well as the semantic complexity (e.g., the number of contextual objects) of the input tensor 705 against various thresholds to select the number of local attention operations. For example, if the input tensor 705 satisfies a first size threshold for high resolution data (e.g., equal to or greater than 4K), the switch component 530 may then evaluate the number of contextual objects. If at least a first number of objects (e.g., three) are depicted, the switch component 530 may determine to use a first number (e.g., three) of local attention operations. If at least a second number of objects (e.g., two) and less than the first number are present, the switch component 530 may determine to use a second number (e.g., two) of local attention operations. Otherwise (e.g., if one or fewer contextual objects are present), the switch component 530 may determine to use a third number (e.g., one) of local attention operations.

As another example, if the input tensor 705 satisfies a second size threshold for medium resolution data (e.g., equal to or greater than 1K) but does not satisfy the first size threshold, the switch component 530 may then evaluate the number of contextual objects. If at least the second number of objects (e.g., two) are depicted, the switch component 530 may determine to use the second number (e.g., two) of local attention operations. If at least a third number of objects (e.g., one) and less than the second number are present, the switch component 530 may determine to use the third number (e.g., one) of local attention operations. Otherwise (e.g., zero contextual objects are present), the switch component 530 may determine to use a fourth number (e.g., zero) of local attention operations.

As another example, if the input tensor 705 fails to satisfy the first or second size thresholds (e.g., less than 1K), the switch component 530 may then evaluate the number of contextual objects. If at least the third number of objects (e.g., one) are depicted, the switch component 530 may determine to use the third number (e.g., one) of local attention operations. Otherwise, (e.g., zero contextual objects are present), the switch component 530 may determine to use a fourth number (e.g., zero) of local attention operations.

In some aspects, the switch component 530 may similarly evaluate the spatial resolution of the target output of the model, and/or the resolution of the display(s) that will be used to display the output of the model, against three resolution thresholds: a first threshold for high resolution output and/or displays (e.g., equal to or greater than (M×N) number of elements in the spatial dimensions), a second threshold for middle resolution output and/or displays (e.g., equal to or greater than (O×P) number of elements in the spatial dimensions, where O and/or P are less than M and/or N, respectively), and a third threshold for low resolution output and/or displays (e.g., equal to or greater than (Q×R) number of elements in the spatial dimensions, where Q and/or R are less than 0 and/or P, respectively). For example, the first resolution threshold may correspond to displaying the output via a large resolution screen such as a 4K television (e.g., having spatial dimensionality of at least 4,096 elements in width and 2,160 elements in height), the second resolution threshold may correspond to a medium resolution display (e.g., having spatial dimensionality of at least 2,048 elements in width and 1,080 elements in height), and the third resolution threshold may correspond to a low resolution display (e.g., a tablet), such as 1K (e.g., having spatial dimensionality of at least 1,024 elements in width and 540 elements in height).

As one example mapping, in some aspects, the switch component 530 may determine to provide the input tensor 705 to the first local attention block 710A via the link 708A (e.g., to use three local attentions) if the input tensor 705 satisfies the first (highest) resolution threshold and the first (highest) complexity threshold (e.g., if the input tensor 705 is at least 4K and contains at least three contextual objects). If the input tensor 705 satisfies the first resolution threshold and the second (middle) complexity threshold but fails to satisfy the first complexity threshold (e.g., if the input tensor 705 is at least 4K and contains two contextual objects), the switch component 530 may provide the input tensor 705 to the second local attention block 710B via the link 708B (e.g., to use two local attentions). If the input tensor 705 satisfies the first resolution threshold and the third (low) complexity threshold but fails to satisfy the second complexity threshold (e.g., if the input tensor 705 is at least 4K and contains one contextual object), the switch component 530 may provide the input tensor 705 to the third local attention block 710C via the link 708C (e.g., to use a single local attention).

As another example mapping, in some aspects, the switch component 530 may determine to provide the input tensor 705 to the second local attention 710B via the link 708B (e.g., to use two local attentions) if the input tensor 705 satisfies the second (middle) resolution threshold and the second (middle) complexity threshold but fails to satisfy the first resolution threshold (e.g., if the input tensor 705 is at least 2K and contains at least two contextual objects). If the input tensor 705 satisfies the second resolution threshold and the third (low) complexity threshold but fails to satisfy the first resolution threshold and the second complexity threshold (e.g., if the input tensor 705 is at least 2K and contains a single contextual object), the switch component 530 may provide the input tensor 705 to the third local attention block 710C via the link 708C (e.g., to use a single local attention).

As yet another example mapping, in some aspects, the switch component 530 may determine to provide the input tensor 705 to the third local attention block 710C via the link 708C (e.g., to use a single local attention) if the input tensor 705 satisfies the third (low) resolution threshold and the third (low) complexity threshold but fails to satisfy the second resolution threshold (e.g., if the input tensor 705 is at least 1K and contains at least one contextual object). If the input tensor 705 satisfies the third resolution threshold and does not satisfy the third complexity threshold, (e.g., if the input tensor 705 is at least 1K and contains no contextual objects), the switch component 530 may provide the input tensor 705 directly to the global attention block 725 via the link 708D (e.g., to refrain from using any local attention).

As yet another example, in some aspects, if the input tensor 705 fails to satisfy the third (low) complexity threshold (e.g., if the input tensor 705 contains no contextual objects), the switch component 530 may provide the input tensor 705 directly to the global attention block 725 via the link 708D (e.g., to use zero local attentions) regardless of the resolution of the input tensor 705.

As discussed above, these mappings and rules are merely provided as examples for conceptual clarity, and other rules and thresholds may be used depending on the particular implementation. Generally, the switch component 530 may be configured to select the number of local attentions to use to process the input tensor 705 in order to use more local attention operations when the input is more complex (e.g., has more contextual objects) and/or is larger resolution, and fewer (or no) local attention operations when the input is less complex (e.g., has fewer contextual objects) and/or is smaller resolution. That is, the number of local attention operations to be applied may be directly proportional to the complexity and/or resolution of the input tensor 705.

In the illustrated example, if the first local attention block 710A is selected, the data corresponding to the input tensor generally passes through each local attention block 710 in turn until the global attention block is applied, and the resulting feature maps 715 and 730 generated by each can be aggregated using an aggregation component 745 to generate the output tensor 755 of the architecture 700.

Specifically, in the illustrated example, if the local attention block 710A is selected, the input tensor 705 is first provided to this local attention block 710A. Although not included in the illustrated example, in some aspects, the input tensor 705 may undergo slicing and/or reshaping prior to being processed by the local attention block 710A. As used herein, slicing and reshaping may both generally refer to modifying the shape or arrangement of a tensor (e.g., where slicing results in a set of slices or segments, and reshaping rearranges the dimensionality). For example, in some aspects, if the input tensor 705 is three-dimensional (e.g., having dimensionality (H×W×C)), the input tensor 705 may be reshaped into a two-dimensional tensor (e.g., having dimensionality (HW×C)) prior to being provided as input to the local attention block 710A. Similarly, in some aspects, the input tensor 705 (or the reshaped tensor) may be sliced (e.g., using regional and/or axial slicing) to generate slices prior to being provided to the local attention block 710A (or within the local attention block 710A).

As discussed above, the local attention block 710A may generally apply local attention to the input tensor 705 (or the reshaped input tensor 705 and/or slices generated therefrom), such as by applying a local attention to each slice using a set of trained local attention parameters (such as the local attention parameters 225 of FIG. 2). As illustrated, the local attention block 710A outputs a feature map 715A (e.g., a local attention output tensor). Although not depicted in the illustrated example, in some aspects, the feature map 715A is generated by de-slicing and/or reshaping the local attention of each slice. For example, as discussed above, a local attention tensor may be generated for each slice, and these local attention tensors may be de-sliced and/or reshaped (e.g., to transform the output from a stacked slice shape to a tensor having the same dimensionality as the input tensor 705). In some aspects, the local attention is de-sliced (e.g., the slice attentions are stacked) but the tensor is not re-shaped (e.g., the feature map 715A remains with dimensionality (HW×C)). As illustrated, this feature map 715A is provided to the aggregation component 745, discussed in more detail below.

Additionally, in the illustrated example, the feature map 715A is provided to the local attention block 710B. Although not depicted in the illustrated example, in some aspects, the feature map 715A may be downsampled prior to being provided to the local attention block 710B, as discussed in more detail below. The local attention block 710B may generally implement the same local attention approach as the local attention block 710A, but on the feature map 715A and using a (potentially) different set of learned parameters.

As discussed above, the local attention block 710B may generally apply local attention to the feature map 715A (or a reshaped feature map 715A and/or slices generated therefrom), such as by applying a local attention to each slice using a set of trained local attention parameters (such as the local attention parameters 225 of FIG. 2). As illustrated, the local attention block 710B outputs a feature map 715B (e.g., a local attention output tensor). Although not depicted in the illustrated example, in some aspects, the feature map 715B is generated by de-slicing and/or reshaping the local attention of each slice. For example, as discussed above, a local attention tensor may be generated for each slice, and these local attention tensors may be de-sliced and/or reshaped.

Further, in the illustrated example, if the switch component 530 determines to use two local attentions, the first local attention block 710A may be unused, and the input tensor 705 may be provided as input to the local attention block 710B (rather than the feature map 715A) to generate the feature map 715B. In some aspects, as discussed above, the input tensor 705 may first be downsampled prior to being provided to the local attention block 710B.

As illustrated, this feature map 715B is provided to the aggregation component 745, discussed in more detail below. Although not depicted in the illustrated example, in some aspects, the feature map 715B may first be upsampled prior to being provided to the aggregation component 745, as discussed in more detail below.

Additionally, in the illustrated example, the feature map 715B is provided to the third local attention block 710C. Although not depicted in the illustrated example, in some aspects, the feature map 715B may be downsampled prior to being provided to the local attention block 710C, as discussed in more detail below. The local attention block 710C may generally implement the same local attention approach as the local attention blocks 710A and 710B, but on the feature map 715B and using a (potentially) different set of learned parameters.

As discussed above, the local attention block 710C may generally apply local attention to the feature map 715B (or a reshaped feature map 715B and/or slices generated therefrom), such as by applying a local attention to each slice using a set of trained local attention parameters (such as the local attention parameters 225 of FIG. 2). As illustrated, the local attention block 710C outputs a feature map 715C (e.g., a local attention output tensor). Although not depicted in the illustrated example, in some aspects, the feature map 715C is generated by de-slicing and/or reshaping the local attention of each slice. For example, as discussed above, a local attention tensor may be generated for each slice, and these local attention tensors may be de-sliced and/or reshaped.

Further, in the illustrated example, if the switch component 530 determines to use a single local attention, the first and second local attention blocks 710A and 710B may be unused, and the input tensor 705 may be provided as input to the local attention block 710C (rather than the feature map 715B) to generate the feature map 715C. In some aspects, as discussed above, the input tensor 705 may first be downsampled prior to being provided to the local attention block 710C.

As illustrated, this feature map 715C is provided to the aggregation component 745, discussed in more detail below. Although not depicted in the illustrated example, in some aspects, the feature map 715C may first be upsampled prior to being provided to the aggregation component 745, as discussed in more detail below.

Additionally, in the illustrated example, the feature map 715C is provided to the global attention block 725. Although not depicted in the illustrated example, in some aspects, the feature map 715C may be downsampled prior to being provided to the global attention block 725, as discussed in more detail below. As discussed above, the global attention block 725 may generally apply global attention to the feature map 715C, such as by pooling or aggregating some elements of the feature map 715C (e.g., using the slice embedding element 235 of FIG. 2), and applying a global attention to the tensor using a set of trained global attention parameters (such as the global attention parameters 255 of FIG. 2). As illustrated, the global attention block 725 outputs a feature map 730 (e.g., a global attention output tensor). Although not depicted in the illustrated example, in some aspects, the feature map 730 is generated by reshaping the global attention output.

Further, in the illustrated example, if the switch component 530 determines to refrain from using any local attention, the first, second, and third local attention blocks 710A, 710B, and 710C may be unused, and the input tensor 705 may be provided as input to the global attention block 725 (rather than the feature map 715C) to generate the feature map 730. In some aspects, as discussed above, the input tensor 705 may first be downsampled prior to being provided to the global attention block 725.

As illustrated, this feature map 730 is provided to the aggregation component 745, discussed in more detail below. Although not depicted in the illustrated example, in some aspects, the feature map 730 may first be upsampled prior to being provided to the aggregation component 745, as discussed in more detail below.

The aggregation component 745 may generally be used to combine or aggregate the generated attention outputs from any attention blocks that were used (e.g., the three local attention outputs, corresponding to feature maps 715A-C, if all three levels were used, as well as the feature map 730 from the global attention block 725) to generate the output tensor 755. Generally, the particular operations performed by the aggregation component 745 may vary depending on the particular implementation. For example, the aggregation component 745 may concatenate the feature maps together (e.g., in the depth dimension). For example, if each of the feature maps 715A-C have dimensionality (H×W×C), the aggregation component 745 may concatenate the maps to generate a concatenated tensor having dimensionality (H×W×4C). Of course, if fewer than three local attentions are used, the concatenated tensor may be smaller in the channel dimension.

In some aspects, the aggregation component 745 may additionally or alternatively perform other operations to merge the feature maps, such as elementwise addition, channel mixing (e.g., convolutions to reduce the channel depth of the tensor), and the like.

The output tensor 755 may then be provided as output from the architecture 700 (e.g., as input to a subsequent layer in the model, or as output from the model). In some aspects, the output tensor 755 may correspond to the output of one of the slice attention layers 620 of FIG. 6, such as a feature map 625.

Although the illustrated example depicts three local attention blocks 710A-C and a single global attention block 725, in some aspects, the architecture may include more or fewer local attention blocks 710 and/or more global attention blocks 725. In some aspects, by using this sequence of local attentions, the architecture 700 provides multi-scale local attention (e.g., local attention at multiple different scales, due to the downsampling blocks 720) in conjunction with global attention. This can improve robustness and accuracy of the composite slice vision transformers disclosed herein.

Further, by dynamically selecting the number of local attention blocks 710 to use based on the input tensor 705, the architecture 700 may enable substantial reductions in computational expense. For example, inputs that are less complex (e.g., have fewer foreground objects) and/or are smaller (e.g., have smaller resolution) may be efficiently and accurately processed using fewer local attention operations, thereby reducing the time, power consumption, heat generation, and other computational expense of processing the data. In contrast, inputs that are more complex (e.g., have more foreground objects) and/or are larger (e.g., have larger resolution) may be more accurately processed using more local attention operations, thereby reserving the expended time, power consumption, heat generation, and other computational expense of processing the data for more complex inputs.

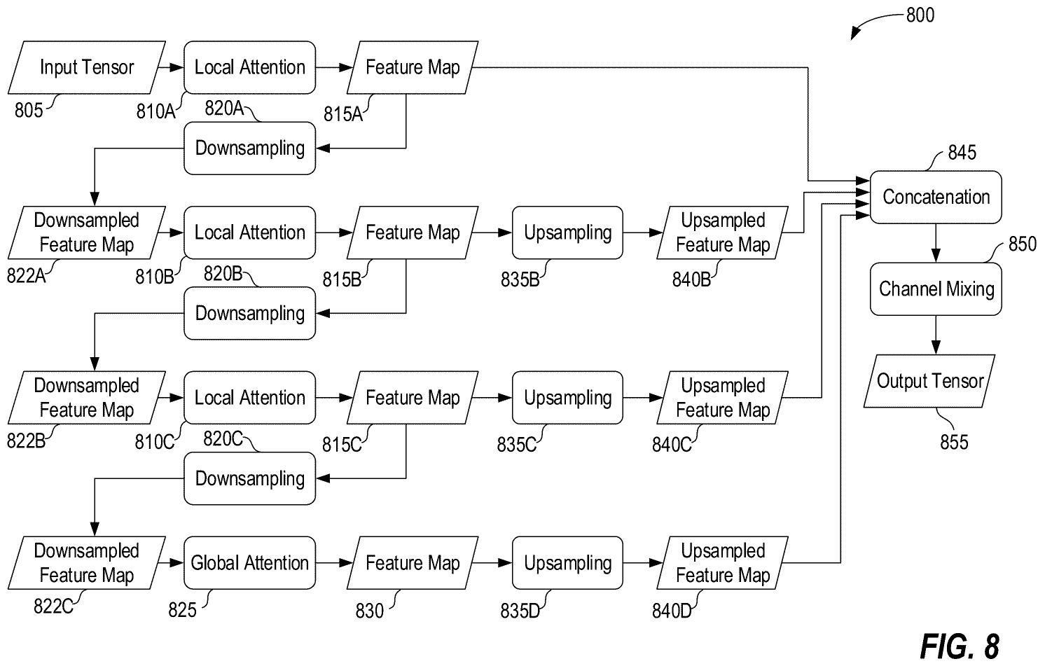

FIGS. 8-11, discussed below in more detail, describe various architectures to implement the multi-scale local and global attention described above. In some aspects, the switch component 530 may be used in each of the below-discussed architectures to similarly enable dynamic selection of alternative attention schemes (e.g., a different number of local attentions), as discussed above.

Example Architecture for Composite Slice Vision Transformers with Multi-Scale Local Attention Using Tensor Downsampling

FIG. 8 depicts an example architecture 800 for composite slice vision transformers with multi-scale local attention using tensor downsampling. In some aspects, the architecture 800 corresponds to or provides more detail for a slice attention layer, such as the slice attention layer 206 of FIG. 2 and/or the slice attention layer 620 of FIG. 6. That is, local attention blocks 810A-C (collectively, local attention blocks 810) may each correspond to the local attention discussed above with reference to the section 215 of FIG. 2, and a global attention block 825 may correspond to the global attention discussed above with reference to the section 245 of FIG. 2. Although a single slice attention layer is depicted by the architecture 800, as discussed above, the architecture 800 may act as one of multiple slice attention layers in a transformer-based machine learning model (e.g., multiple such attention layers may be used in sequence to process input data).

Although not depicted in the illustrated example, in some aspects, the architecture 800 may similarly implement a dynamic selection or modification of the attention procedures, as discussed above with reference to FIG. 7. For example, a switch component (such as the switch component 530 of FIGS. 5 and/or 7) may be used to select which local attention block(s) to use, rather than using all three, as discussed above. The input may then be provided to the selected local attention block directly, reducing the computational complexity of the architecture 800.

In the illustrated example, an input tensor 805 (which may correspond to the input tensor 705 of FIG. 7) is accessed. For example, the input tensor 805 may be received as input to a machine learning model (e.g., if the architecture 800 corresponds to the first layer), or may be received as the output of a prior layer in the model. In some aspects, as discussed above, the input tensor 805 comprises image data. That is, the input tensor 805 may be an image (e.g., as input to the model) and/or may include data generated based on an input image (e.g., an attention output or other feature map generated by one or more prior layers based on an input image).

In the illustrated example, the input tensor 805 is first processed using the local attention block 810A (which may correspond to the local attention block 710A of FIG. 7). Although not included in the illustrated example, in some aspects, the input tensor 805 may undergo slicing and/or reshaping prior to being processed by the local attention block 810A. As used herein, slicing and reshaping may both generally refer to modifying the shape or arrangement of a tensor (e.g., where slicing results in a set of slices or segments, and reshaping rearranges the dimensionality). For example, in some aspects, if the input tensor 805 is three-dimensional (e.g., having dimensionality (H×W×C)), the input tensor 805 may be reshaped into a two-dimensional tensor (e.g., having dimensionality (HW×C)) prior to being provided as input to the local attention block 810A. Similarly, in some aspects, the input tensor 805 (or the reshaped tensor) may be sliced (e.g., using regional and/or axial slicing) to generate slices prior to being provided to the local attention block 810A (or within the local attention block 810A).

As discussed above, the local attention block 810A may generally apply local attention to the input tensor 805 (or the reshaped input tensor 805 and/or slices generated therefrom), such as by applying a local attention to each slice using a set of trained local attention parameters (such as the local attention parameters 225 of FIG. 2). As illustrated, the local attention block 810A outputs a feature map 815A (e.g., a local attention output tensor). Although not depicted in the illustrated example, in some aspects, the feature map 815A is generated by de-slicing and/or reshaping the local attention of each slice. For example, as discussed above, a local attention tensor may be generated for each slice, and these local attention tensors may be de-sliced and/or reshaped (e.g., to transform the output from a stacked slice shape to a tensor having the same dimensionality as the input tensor 805). In some aspects, the local attention is de-sliced (e.g., the slice attentions are stacked) but the tensor is not re-shaped (e.g., the feature map 815A remains with dimensionality (HW×C). As illustrated, this feature map 815A is provided to a concatenation block 845, discussed in more detail below.

Additionally, in the illustrated example, the feature map 815A is provided to a downsampling block 820A. The downsampling block 820A generally downsamples the local attention output from the local attention block 810A (e.g., the feature map 815A) based on a spatial hyperparameter to generate a downsampled local attention output or tensor (depicted as downsampled feature map 822A). For example, a spatial hyperparameter r may be used to reduce the size of the feature map 815A, such as by dividing each spatial dimension by r (e.g., pooling or otherwise aggregating the values in neighboring elements to reduce the size of the tensor). That is, if the input tensor 805 and feature map 815A each have dimensionality (H×W×C), the downsampling block 820A may generate a downsampled feature map 822A having dimensionality

$$( \frac{H}{r} \times \frac{W}{r} \times C ) .$$

In some aspects, the downsampling block 820A may downsample the two-dimensional feature map to size

$$( \frac{H W}{{r}^{2}} \times C )$$

directly (e.g., if the feature map 815A is not reshaped to three dimensions). In some aspects, the downsampled feature map 822A may additionally or alternatively have a different channel depth (e.g., having depth C₂). In some aspects, the value of the spatial hyperparameter r may be selected or defined using a variety of criteria or techniques, and can generally include any value. For example, the spatial hyperparameter may be selected (e.g., by a data scientist) to balance complexity and/or to improve model accuracy (e.g., using trial and error to test multiple values).

In the illustrated example, this downsampled feature map 822A is then provided as input to the local attention block 810B (which may correspond to the local attention block 710B of FIG. 7). The local attention block 810B may generally implement the same local attention approach as the local attention block 810A, but on the downsampled feature map 822A and using a (potentially) different set of learned parameters.

Although not included in the illustrated example, in some aspects, the downsampled feature map 822A may undergo slicing and/or reshaping prior to being processed by the local attention block 810B, as discussed above. For example, in some aspects, if the downsampled feature map 822A has dimensionality

$$( \frac{H}{r} \times \frac{W}{r} \times C ) ,$$

the downsampled feature map 822A may be reshaped into a two-dimensional tensor (e.g., having dimensionality

$$( \frac{H}{r} \frac{W}{r} \times C )$$

) prior to being provided as input to the local attention block 810B (e.g., if the downsampled feature map 822A is not already in two dimensions). Similarly, in some aspects, the downsampled feature map 822A (or the reshaped tensor) may be sliced (e.g., using regional and/or axial slicing) to generate slices prior to being provided to the local attention block 810B (or within the local attention block 810B).

As discussed above, the local attention block 810B may generally apply local attention to the downsampled feature map 822A (or the reshaped downsampled feature map 822A and/or slices generated therefrom), such as by applying a local attention to each slice using a set of trained local attention parameters (such as the local attention parameters 225 of FIG. 2). As illustrated, the local attention block 810B outputs a feature map 815B (e.g., a local attention output tensor). Although not depicted in the illustrated example, in some aspects, the feature map 815B is generated by de-slicing and/or reshaping the local attention of each slice. For example, as discussed above, a local attention tensor may be generated for each slice, and these local attention tensors may be de-sliced and/or reshaped (e.g., to transform the output from a stacked slice shape to a tensor having the same dimensionality as the downsampled feature map 822A, which may be two-dimensional or three-dimensional in some aspects, as discussed above).

As illustrated, this feature map 815B is provided to an upsampling block 835B. The upsampling block 835B generally upsamples the local attention output from the local attention block 810B (e.g., the feature map 815B) based on the spatial hyperparameter to generate an upsampled local attention output or tensor (depicted as an upsampled feature map 840B). For example, the spatial hyperparameter r may be used to increase the size of the feature map 815B, such as by multiplying each spatial dimension by r (e.g., duplicating one or more elements to increase the size of the tensor). That is, if the feature map 815B has dimensionality

$$( \frac{H}{r} \times \frac{W}{r} \times C ) ,$$

the upsampling block 835B may generate an upsampled feature map 840B having dimensionality (H×W×C) that matches the dimensionality of the input tensor 805 and the feature map 815A. This upsampled feature map 840B is then provided to the concatenation block 845, discussed in more detail below.

Additionally, in the illustrated example, the feature map 815B is provided to a second downsampling block 820B. The downsampling block 820B may generally downsample the local attention output from the local attention block 810B (e.g., the feature map 815B) based on a spatial hyperparameter, as discussed above, to generate a downsampled local attention output or tensor (depicted as downsampled feature map 822B). In some aspects, a different spatial hyperparameter r_{B} may be used by the downsampling block 820B (e.g., where the first downsampling block 820A uses a first hyperparameter r_{A}). In other aspects, the downsampling block 820B may use the same spatial hyperparameter as the downsampling block 820A. For example, the downsampling block 820B may reduce the size of the feature map 815B by dividing each spatial dimension by r again. That is, if the downsampled feature map 822A and feature map 815B each have dimensionality

$$( \frac{H}{r} \times \frac{W}{r} \times C ) ,$$

the downsampling block 820B may generate a downsampled feature map 822B having dimensionality

$$( \frac{H}{{r}^{2}} \times \frac{W}{{r}^{2}} \times C ) .$$

In some aspects, the downsampled feature map 822B may additionally or alternatively have a different channel depth (e.g., having depth C₃).

In the illustrated example, this downsampled feature map 822B is then provided as input to a third local attention block 810C (which may correspond to the local attention block 710C of FIG. 7). The local attention block 810C may generally implement the same local attention approach as the local attention blocks 810A and 810B, but on the downsampled feature map 822B and using a (potentially) different set of learned parameters.

Although not included in the illustrated example, in some aspects, the downsampled feature map 822B may undergo slicing and/or reshaping prior to being processed by the local attention block 810C, as discussed above. For example, in some the aspects, if the downsampled feature map 822B has dimensionality

$$( \frac{H}{{r}^{2}} \times \frac{W}{{r}^{2}} \times C ) ,$$

the downsampled feature map 822B may be reshaped into a two-dimensional tensor (e.g., having dimensionality

$$( \frac{H}{{r}^{2}} \frac{W}{{r}^{2}} \times C )$$

) prior to being provided as input to the local attention block 810C (e.g., if the downsampled feature map 822B is not already in two dimensions). Similarly, in some aspects, the downsampled feature map 822B (or the reshaped tensor) may be sliced (e.g., using regional and/or axial slicing) to generate slices prior to being provided to the local attention block 810C (or within the local attention block 810C).

As discussed above, the local attention block 810C may generally apply local attention to the downsampled feature map 822B (or the reshaped downsampled feature map and/or slices generated therefrom), such as by applying a local attention to each slice using a set of trained local attention parameters (such as the local attention parameters 225 of FIG. 2). As illustrated, the local attention block 810C outputs a feature map 815C (e.g., a local attention output tensor). Although not depicted in the illustrated example, in some aspects, the feature map 815C is generated by de-slicing and/or reshaping the local attention of each slice. For example, as discussed above, a local attention tensor may be generated for each slice, and these local attention tensors may be de-sliced and/or reshaped (e.g., to transform the output from a stacked slice shape to a tensor having the same dimensionality as the downsampled feature map 822B, which may be two-dimensional or three-dimensional in some aspects, as discussed above).

As illustrated, this feature map 815C is provided to an upsampling block 835C. As discussed above with respect to the upsampling block 835B, the upsampling block 835C generally upsamples the local attention output from the local attention block 810C (e.g., the feature map 815C) based on the spatial hyperparameter to generate an upsampled local attention output or tensor (depicted as upsampled feature map 840C) that has the same dimensionality as the input tensor 805. For example, the spatial hyperparameter r may be used to increase the size of the feature map 815C (e.g., from dimensionality

$$( \frac{H}{{r}^{2}} \times \frac{W}{{r}^{2}} \times C )$$

to dimensionality (H×W×C)). This upsampled feature map 840C is then provided to the concatenation block 845, discussed in more detail below.

Additionally, in the illustrated example, the feature map 815C is provided to a third downsampling block 820C. The downsampling block 820C may generally downsample the local attention output from the local attention block 810C (e.g., the feature map 815C) based on a spatial hyperparameter, as discussed above, to generate a downsampled local attention output or tensor (depicted as downsampled feature map 822C). In some aspects, a different spatial hyperparameter r_{C} may be used by the downsampling block 820C. In other aspects, the downsampling block 820C may use the same spatial hyperparameter as the downsampling blocks 820A and 820B. For example, the downsampling block 820C may reduce the size of the feature map 815C by dividing each spatial dimension by r again. That is, if the downsampled feature map 822B and feature map 815C each have dimensionality

$$( \frac{H}{{r}^{2}} \times \frac{W}{{r}^{2}} \times C ) ,$$

the downsampling block 820C may generate a downsampled feature map 822C having dimensionality

$$( \frac{H}{{r}^{4}} \times \frac{W}{{r}^{4}} \times C )$$

or

$$( \frac{H}{{r}^{3}} \times \frac{W}{{r}^{3}} \times C ) .$$

In some aspects, the downsampled feature map 822C may additionally or alternatively have a different channel depth (e.g., having depth C₄).

In the illustrated example, this downsampled feature map 822C is then provided as input to a global attention block 825 (which may correspond to the global attention block 725 of FIG. 7). Although not included in the illustrated example, in some aspects, the downsampled feature map 822C may undergo reshaping prior to being processed by the global attention block 825. For example, in some aspects, if the downsampled feature map 822C has dimensionality

$$( \frac{H}{{r}^{3}} \times \frac{W}{{r}^{3}} \times C ) ,$$

the downsampled feature map 822C may be reshaped into a two-dimensional tensor (e.g., having dimensionality

$$( \frac{H}{{r}^{3}} \frac{W}{{r}^{3}} \times C )$$

) prior to being proviaca as input to the global attention block 825 (e.g., if the downsampled feature map 822C is not already in two dimensions). In some aspects, as the global attention block 825 is performed globally, the downsampled feature map 822C may not be sliced.

As discussed above, the global attention block 825 may generally apply global attention to the downsampled feature map 822C, such as by pooling or aggregating some elements of the downsampled feature map 822C (e.g., using the slice embedding element 235 of FIG. 2), and applying a global attention to the tensor using a set of trained global attention parameters (such as the global attention parameters 255 of FIG. 2). As illustrated, the global attention block 825 outputs a feature map 830 (e.g., a global attention output tensor). Although not depicted in the illustrated example, in some aspects, the feature map 830 is generated by reshaping the global attention output. For example, as discussed above, the output may be reshaped (e.g., to transform the output to a tensor having the same dimensionality as the downsampled feature map 822C, which may be two-dimensional or three-dimensional in some aspects, as discussed above).

As illustrated, this feature map 830 is provided to an upsampling block 835D. Similar to the upsampling blocks 835B, 835C discussed above, the upsampling block 835D generally upsamples the global attention output from the global attention block 825 (e.g., the feature map 830) based on the spatial hyperparameter to generate an upsampled global attention output or tensor (depicted as an upsampled feature map 840D) that has the same dimensionality as the input tensor 805. For example, the spatial hyperparameter r may be used to increase the size of the feature map 830 (e.g., from dimensionality

$$( \frac{H}{{r}^{3}} \times \frac{W}{{r}^{3}} \times C )$$

to dimensionality (H×W×C)). This upsampled feature map 840D is then provided to the concatenation block 845, discussed in more detail below.

In the illustrated architecture 800, the concatenation block 845 may generally combine or aggregate the feature map 815A and the upsampled feature maps 840B, 840C, and 840D, such as by concatenating the maps together (e.g., in the depth dimension). For example, if each of the feature map 815A and the upsampled feature maps 840B, 840C, and 840D has dimensionality (H×W×C), the concatenation block 845 may concatenate the maps to generate a concatenated tensor having dimensionality (H×W×4C).

As illustrated, this concatenated tensor is then processed by a channel mixing block 850 to generate an output tensor 855 (which may correspond to the output tensor 755 of FIG. 7). For example, the channel mixing block 850 may perform operations such as one or more convolutions to reduce the size of the concatenated tensor (e.g., such that the output tensor 855 has dimensionality that matches the input tensor 805, such as (H×W×C)).

The output tensor 855 may then be provided as output from the architecture 800 (e.g., as input to a subsequent layer in the model, or as output from the model).

Although the illustrated example depicts three local attention blocks 810A-C and a single global attention block 825, in some aspects, the architecture may include more or fewer local attention blocks 810 and/or more global attention blocks 825. In some aspects, by using this sequence of local attentions, the architecture 800 provides multi-scale local attention (e.g., local attention at multiple different scales, due to the downsampling blocks 820) in conjunction with global attention. This can improve robustness and accuracy of the composite slice vision transformers disclosed herein.

Further, in some aspects, the architecture 800 may dynamically select the number of local attention blocks 810 to use based on the input tensor 805, as discussed above. Such a dynamic selection may enable substantial reductions in computational expense. For example, inputs that are less complex (e.g., have fewer foreground objects) and/or are smaller (e.g., have smaller resolution) may be efficiently and accurately processed using fewer local attention operations, thereby reducing the time, power consumption, heat generation, and other computational expense of processing the data. In contrast, inputs that are more complex (e.g., have more foreground objects) and/or are larger (e.g., have larger resolution) may be more accurately processed using more local attention operations, thereby reserving the expended time, power consumption, heat generation, and other computational expense of processing the data for more complex inputs.

In some aspects, the query matrix, key matrix, and value matrix of each local attention block 810 and global attention block 825 generally correspond to the dimensionality of the input tensor to the respective block. For example, if the input tensor 805 has (or is reshaped to have) dimensionality (HW×C), the query matrix, key matrix, and value matrix of the local attention block 810A may similarly have dimensionality (HW×C). As an additional example, if the downsampled feature map 822A has dimensionality

$$( \frac{H}{r} \frac{W}{r} \times C ) ,$$

the query matrix, key matrix, and value matrix of the local attention block 810B may similarly have dimensionality

$$( \frac{H}{r} \frac{W}{r} \times C ) .$$

Further, the query matrix, key matrix, and value matrix of the local attention block 810C may have dimensionality

$$( \frac{H}{{r}^{2}} \frac{W}{{r}^{2}} \times C )$$

(matching the dimensionality of the downsampled feature map 822B), and the query matrix, key matrix, and value matrix of the global attention block 825 may have dimensionality

$$( \frac{H}{{r}^{3}} \frac{H}{{r}^{3}} \times C )$$

(matching the dimensionality of the downsampled feature map 822C).

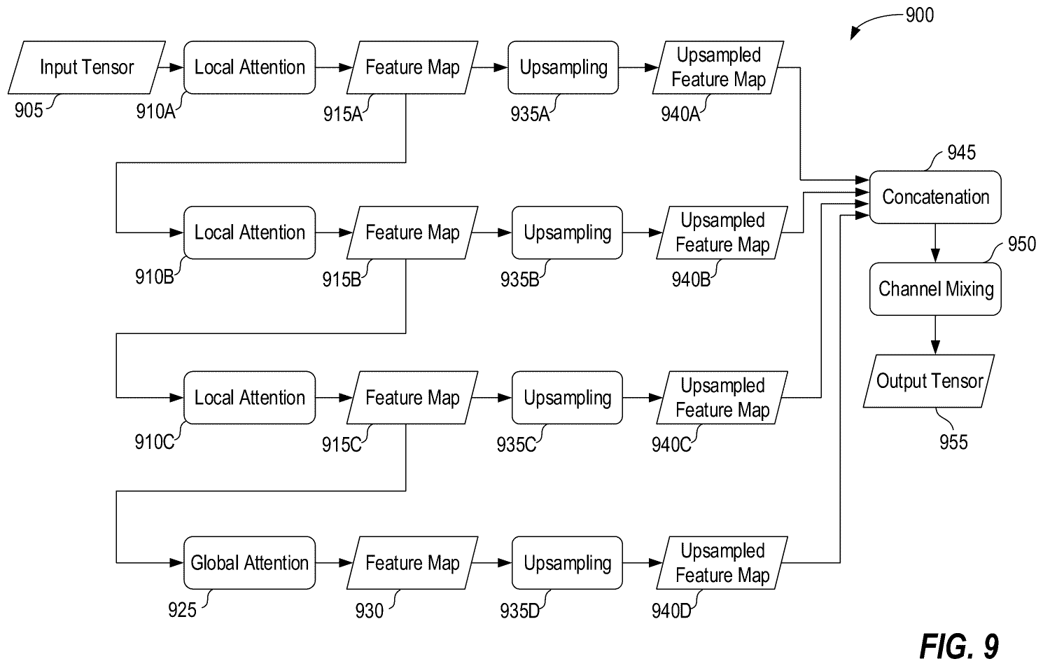

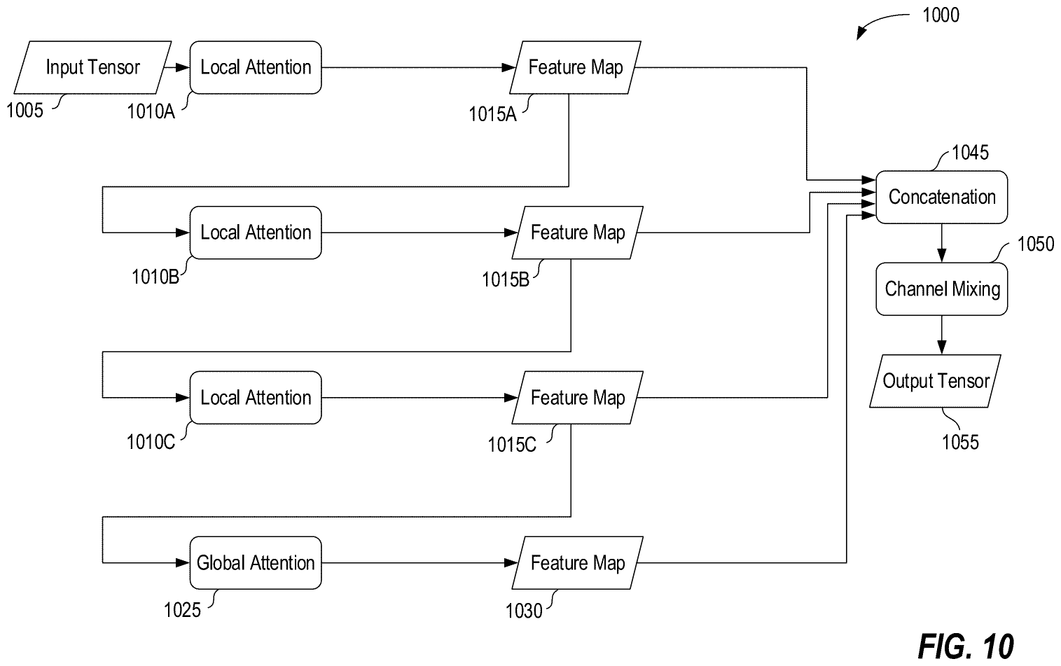

In some aspects, in addition to or instead of downsampling the tensors between attention blocks (using downsampling blocks 820A-C), some or all of the attention matrices themselves may be downsampled. For example, in some aspects, the query matrices of each attention block may be downsampled, as discussed below with reference to FIG. 9. Similarly, in some aspects, the key and value matrices of each attention block may be downsampled, as discussed below with reference to FIG. 10. This intra-attention downsampling may obviate downsampling between attention blocks, as discussed in more detail below.

Example Architecture for Composite Slice Vision Transformers with Multi-Scale Local Attention Using Downsampled Query Tensors

FIG. 9 depicts an example architecture 900 for composite slice vision transformers with multi-scale local attention using downsampled query tensors (e.g., query matrices) in the attention blocks. In some aspects, the architecture 900 corresponds to or provides more detail for a slice attention layer, such as the slice attention layer 206 of FIG. 2 and/or the slice attention layer 620 of FIG. 6. That is, local attention blocks 910A-C (collectively, local attention blocks 910) may each correspond to the local attention discussed above with reference to the section 215 of FIG. 2, and a global attention block 925 may correspond to the global attention discussed above with reference to the section 245 of FIG. 2. Although a single slice attention layer is depicted by the architecture 900, as discussed above for other architectures, the architecture 900 may act as one of multiple slice attention layers in a transformer-based machine learning model (e.g., multiple such attention layers may be used in sequence to process input data).

Although not depicted in the illustrated example, in some aspects, the architecture 900 may similarly implement a dynamic selection or modification of the attention procedures, as discussed above with reference to FIG. 7. For example, a switch component (such as the switch component 530 of FIGS. 5-6) may be used to select which local attention block(s) to use, rather than using all three, as discussed above. The input may then be provided to the selected local attention block directly, reducing the computational complexity of the architecture 900.

In the illustrated example, an input tensor 905 (which may correspond to the input tensor 705 of FIG. 7) is accessed. For example, the input tensor 905 may be received as input to a machine learning model (e.g., if the architecture 900 corresponds to the first layer), or may be received as the output of a prior layer in the model. In some aspects, as discussed above, the input tensor 905 comprises image data. That is, the input tensor 905 may be an image (e.g., as input to the model) and/or may include data generated based on an input image (e.g., an attention output or other feature map generated by one or more prior layers based on an input image).

In the illustrated example, the input tensor 905 is first processed using the local attention block 910A (which may correspond to the local attention block 710A of FIG. 7). Although not included in the illustrated example, in some aspects, the input tensor 905 may undergo slicing and/or reshaping prior to being processed by the local attention block 910A, as discussed above for other architectures. For example, if the input tensor 905 has dimensionality (H×W×C), the input tensor 905 may be reshaped into a two-dimensional tensor (e.g., having dimensionality (HW× C)) prior to being provided as input to the local attention block 910A. Similarly, in some aspects, the input tensor 905 (or the reshaped tensor) may be sliced (e.g., using regional and/or axial slicing) to generate slices prior to being provided to the local attention block 910A (or within the local attention block 910A).

As discussed above, the local attention block 910A may generally apply local attention to the input tensor 905 (or the reshaped input tensor 905 and/or slices generated therefrom), such as by applying a local attention to each slice using a set of trained local attention parameters (such as the local attention parameters 225 of FIG. 2).

In the illustrated example, processing the input tensor 905 (or the reshaped input tensor) using the local attention block 910A may include generating a query matrix, key matrix, and value matrix based on trained weights, as discussed above. In some aspects, the query matrix may be downsampled based on a spatial hyperparameter r, as discussed above, while the key and value matrices may be unchanged. As discussed above, the size of the output tensor (e.g., a feature map 915A) generally matches the size of the query matrix used by the attention. For example, to achieve a spatial downsampling of r in the height and width dimensions (e.g., such that the feature map 915A has dimensionality

$$( \frac{H}{r} \times \frac{W}{r} \times C )$$

), the query matrix or me local attention block 910A may be downsampled to size

$$( \frac{HW}{{r}^{2}} \times C ) .$$

As illustrated, the local attention block 910A generates the feature map 915A (e.g., a local attention output tensor). Although not depicted in the illustrated example, in some aspects, the feature map 915A is generated by de-slicing and/or reshaping the local attention of each slice. For example, as discussed above, a local attention tensor may be generated for each slice, and these local attention tensors may be de-sliced and/or reshaped (e.g., to transform the output from a stacked slice shape to a tensor having the same dimensionality as the input tensor 905). In other aspects, as the downsampling is performed within the local attention block 910A, the feature map 915A may be retained in the dimensionality output by the local attention block 910A (e.g.,

$$( \frac{HW}{{r}^{2}} \times C )$$

and used directly as input to the subsequent attention without reshaping to three dimensions, in some aspects.

As illustrated, this feature map 915A is provided to an upsampling block 935A. In some aspects, prior to or during the upsampling in the upsampling block 935A, the feature map 915A may be reshaped (e.g., to three dimensions, such as

$$( \frac{H}{r} \times \frac{W}{r} \times C )$$

The upsampling block 935A then upsamples the feature map 915A based on the spatial hyperparameter r to generate an upsampled feature map 940A having the same dimensionality and/or size of the input tensor 905 (e.g., (H×W×C)). The upsampled feature map 940A is then provided to a concatenation block 945, discussed in more detail below.

Additionally, in the illustrated example, the feature map 915A is provided as input to the local attention block 910B (which may correspond to the local attention block 710B of FIG. 7). The local attention block 910B may generally implement the same local attention approach as the local attention block 910A, but on the feature map 915A and using a (potentially) different set of learned parameters.

Although not included in the illustrated example, in some aspects, the feature map 915A may undergo slicing and/or reshaping prior to being processed by the local attention block 910B, as discussed above. For example, in some aspects, if the feature map 915A has dimensionality

$$( \frac{H}{r} \times \frac{W}{r} \times C ) ,$$

the feature map 915A may be reshaped into a two-dimensional tensor (e.g., having dimensionality

$$( \frac{H}{r} \frac{W}{r} \times C ) or ( \frac{H W}{{r}^{2}} \times C )$$

prior to being provided as input to the local attention block 910B. In some aspects, if the feature map 915A is not reshaped (other than by or prior to the upsampling block 935A), the two-dimensional output of the local attention block 910A (e.g., having size) may

$$( \frac{H W}{{r}^{2}} \times C )$$

) may be provided directly to the local attention block 910B without reshaping.

As discussed above for other local attention blocks, the local attention block 910B may generally apply local attention to the feature map 915A (or the reshaped feature map and/or slices generated therefrom), such as by applying a local attention to each slice using a set of trained local attention parameters (such as the local attention parameters 225 of FIG. 2). As illustrated, the local attention block 910B outputs a feature map 915B (e.g., a local attention output tensor).

In the illustrated example, processing the feature map 915A using the local attention block 910B may include generating a query matrix, key matrix, and value matrix based on trained weights, as discussed above. In some aspects, the query matrix may be further downsampled based on the spatial hyperparameter r, as discussed above, while the key and value matrices may be unchanged. For example, the query matrix of the local attention block 910B may be downsampled to size

$$( \frac{H W}{{r}^{4}} \times C ) ,$$

such that the feature map 915B has (or can be reshaped to have) dimensionality

$$( \frac{H}{{r}^{2}} \times \frac{W}{{r}^{2}} \times C ) .$$

Although not depicted in the illustrated example, in some aspects, the feature map 915B is generated by de-slicing and/or reshaping the local attention of each slice, as discussed above. In some aspects, as the downsampling is performed within the local attention block 910B, the feature map 915B may be retained in the dimensionality output by the local attention block 910B (e.g.,

$$( \frac{H W}{{r}^{4}} \times C )$$

) and used directly as input to the subsequent attention without reshaping to three dimensions.

As illustrated, this feature map 915B is provided to an upsampling block 935B. In some aspects, prior to or in the upsampling block 935B, the feature map 915B may be reshaped (e.g., to three dimensions, such as

$$( \frac{H}{{r}^{2}} \times \frac{W}{{r}^{2}} \times C )$$

). The upsampling block 935B then upsamples the feature map 915B based on the spatial hyperparameter r to generate an upsampled feature map 940B having the same dimensionality and/or size of the input tensor 905 (e.g., (H×W×C)). The upsampled feature map 940B is then provided to the concatenation block 945, discussed in more detail below.

Additionally, in the illustrated example, the feature map 915B is provided as input to the local attention block 910C (which may correspond to the local attention block 710C of FIG. 7). The local attention block 910C may generally implement the same local attention approach as the local attention blocks 910A and 910B, but on feature map 915B and using a (potentially) different set of learned parameters, to generate a feature map 915C.

In some aspects, processing the feature map 915B using the local attention block 910C may include generating a query matrix, key matrix, and value matrix based on trained weights, as discussed above. In some aspects, the query matrix may be further downsampled based on the spatial hyperparameter r, as discussed above, while the key and value matrices may be unchanged. For example, the query matrix of the local attention block 910C may be downsampled to size

$$( \frac{H W}{{r}^{6}} \times C ) ,$$

such that the feature map 915C has (or can be reshaped to have) dimensionality

$$( \frac{H}{{r}^{3}} \times \frac{W}{{r}^{3}} \times C ) .$$

Although not depicted in the illustrated example, in some aspects, the feature map 915C is generated by de-slicing and/or reshaping the local attention of each slice, as discussed above. In some aspects, as the downsampling is performed within the local attention block 910C, the feature map 915C may be retained in the dimensionality output by the local attention block 910C (e.g.,

$$( \frac{H W}{{r}^{6}} \times C )$$

and used directly as input to the subsequent attention without reshaping to three dimensions.

As illustrated, this feature map 915C is provided to an upsampling block 935C. In some aspects, prior to or in the upsampling block 935C, the feature map 915C may be reshaped (e.g., to three dimensions, such as

$$( \frac{H}{{r}^{3}} \times \frac{W}{{r}^{3}} \times C )$$

). The upsampling block 935C then upsamples the feature map 915C based on the spatial hyperparameter r to generate an upsampled feature map 940C having the same dimensionality and/or size of the input tensor 905 (e.g., (H×W×C)). The upsampled feature map 940C is then provided to the concatenation block 945, discussed in more detail below.

Additionally, in the illustrated example, the feature map 915C is provided as input to the global attention block 925 (which may correspond to the global attention block 725 of FIG. 7) to generate a feature map 930. In some aspects, as discussed above, the feature map 915C may be reshaped (e.g., to two dimensions, if the feature map 915C is in three dimensions) prior to application of the global attention block 925.

In some aspects, the global attention block 925 may generally implement global attention as discussed above. In some aspects, the global attention block 925 may perform global attention without downsampling the query, key, or value matrices. That is, the feature map 930 may have the same size and/or dimensionality as the feature map 915C (e.g.,

$$( \frac{H}{{r}^{3}} \times \frac{W}{{r}^{3}} \times C ) or ( \frac{H W}{{r}^{6}} \times C )$$

).

As discussed above, the global attention block 925 may generally apply global attention to the feature map 915C, such as by pooling or aggregating some elements of the feature map 915C (e.g., using the slice embedding element 235 of FIG. 2), and applying a global attention to the tensor using a set of trained global attention parameters (such as the global attention parameters 255 of FIG. 2).

As illustrated, this feature map 930 is provided to an upsampling block 935D. As discussed above for other upsampling blocks, the upsampling block 935D generally upsamples the global attention output from the global attention block 925 (e.g., the feature map 930) based on the spatial hyperparameter r to generate an upsampled global attention output or tensor (depicted as upsampled feature map 940D) that has the same dimensionality as the input tensor 905 (e.g., (H×W×C)). This upsampled feature map 940D is then provided to the concatenation block 945, discussed in more detail below.

In the illustrated architecture 900, the concatenation block 945 may generally combine or aggregate the upsampled feature maps 940A, 940B, 940C, and 940D, such as by concatenating the maps together (e.g., in the depth dimension). For example, if each of the upsampled feature maps 940A, 940B, 940C, and 940D has dimensionality (H×W×C), the concatenation block 945 may concatenate the maps to generate a concatenated tensor having dimensionality (H×W×4C).

As illustrated, this concatenated tensor is then processed by a channel mixing block 950 to generate an output tensor 955 (which may correspond to the output tensor 755 of FIG. 7). For example, the channel mixing block 950 may perform operations such as one or more convolutions to reduce the size of the concatenated tensor (e.g., such that the output tensor 955 has dimensionality that matches the input tensor 905, such as (H×W×C)).

The output tensor 955 may then be provided as output from the architecture 900 (e.g., as input to a subsequent layer in the model, or as output from the model).

Although the illustrated example depicts three local attention blocks 910A-C and a single global attention block 925, in some aspects, the architecture may include more or fewer local attention blocks 910 and/or more global attention blocks 925. In some aspects, by using this sequence of local attentions, the architecture 900 provides multi-scale local attention (e.g., local attention at multiple different scales, due to the downsampling of query matrices) in conjunction with global attention. Additionally, by downsampling the query matrices directly (rather than downsampling between attentions), the architecture 900 may obviate the separate downsampling blocks while retaining the effects of multi-scale attention that uses independent downsampling (e.g., the architecture 800 of FIG. 8). This can improve robustness and accuracy of the composite slice vision transformers disclosed herein.

Further, in some aspects, the architecture 900 may dynamically select the number of local attention blocks 910 to use based on the input tensor 905, as discussed above. Such a dynamic selection may enable substantial reductions in computational expense. For example, inputs that are less complex (e.g., have fewer foreground objects) and/or are smaller (e.g., have smaller resolution) may be efficiently and accurately processed using fewer local attention operations, thereby reducing the time, power consumption, heat generation, and other computational expense of processing the data. In contrast, inputs that are more complex (e.g., have more foreground objects) and/or are larger (e.g., have larger resolution) may be more accurately processed using more local attention operations, thereby reserving the expended time, power consumption, heat generation, and other computational expense of processing the data for more complex inputs.

Example Architecture for Composite Slice Vision Transformers with Multi-Scale Local Attention Using Downsampled Key and Value Tensors

FIG. 10 depicts an example architecture 1000 for composite slice vision transformers with multi-scale local attention using downsampled key and value tensors (e.g., key and value matrices) in the attention blocks. In some aspects, the architecture 1000 corresponds to or provides more detail for a slice attention layer, such as the slice attention layer 206 of FIG. 2 and/or the slice attention layer 620 of FIG. 6. That is, local attention blocks 1010A-C (collectively, local attention blocks 1010) may each correspond to the local attention discussed above with reference to the section 215 of FIG. 2, and a global attention block 1025 may correspond to the global attention discussed above with reference to the section 245 of FIG. 2. Although a single slice attention layer is depicted by the architecture 1000, as discussed above, the architecture 1000 may act as one of multiple slice attention layers in a transformer-based machine learning model (e.g., multiple such attention layers may be used in sequence to process input data).

Although not depicted in the illustrated example, in some aspects, the architecture 1000 may similarly implement a dynamic selection or modification of the attention procedures, as discussed above with reference to FIG. 7. For example, a switch component (such as the switch component 530 of FIGS. 5-6) may be used to select which local attention block(s) to use, rather than using all three, as discussed above. The input may then be provided to the selected local attention block directly, reducing the computational complexity of the architecture 1000.

In the illustrated example, an input tensor 1005 (which may correspond to the input tensor 705 of FIG. 7) is accessed. For example, the input tensor 1005 may be received as input to a machine learning model (e.g., if the architecture 1000 corresponds to the first layer), or may be received as the output of a prior layer in the model. In some aspects, as discussed above, the input tensor 1005 comprises image data. That is, the input tensor 1005 may be an image (e.g., as input to the model) and/or may include data generated based on an input image (e.g., an attention output or other feature map generated by one or more prior layers based on an input image).

In the illustrated example, the input tensor 1005 is first processed using the local attention block 1010A (which may correspond to the local attention block 710A of FIG. 7). Although not included in the illustrated example, in some aspects, the input tensor 1005 may undergo slicing and/or reshaping prior to being processed by the local attention block 1010A, as discussed above. For example, if the input tensor 1005 has dimensionality (H×W×C), the input tensor 1005 may be reshaped into a two-dimensional tensor (e.g., having dimensionality (HW×C)) prior to being provided as input to the local attention block 1010A. Similarly, in some aspects, the input tensor 1005 (or the reshaped tensor) may be sliced (e.g., using regional and/or axial slicing) to generate slices prior to being provided to the local attention block 1010A (or within the local attention block 1010A).

As discussed above for other local attention blocks, the local attention block 1010A may generally apply local attention to the input tensor 1005 (or the reshaped input tensor 1005 and/or slices generated therefrom), such as by applying a local attention to each slice using a set of trained local attention parameters (such as the local attention parameters 225 of FIG. 2).

In the illustrated example, processing the input tensor 1005 (or the reshaped input tensor) using the local attention block 1010A may include generating a query matrix, key matrix, and value matrix based on trained weights, as discussed above. In some aspects, the key and value matrices may be downsampled based on a spatial hyperparameter r, as discussed above, while the query matrix may be unchanged. As discussed above, the size of the output tensor (e.g., a feature map 1015A) generally matches the size of the query matrix used by the attention. Therefore, if the query matrix of the local attention block 1010A matches the size of the input tensor 1005 (e.g., (HW×C)), the feature map 1015A may have size (HW×C) and/or may be reshaped to (H×W×C).

In some aspects, each of the key and value matrices may be downsampled based on the spatial hyperparameter (e.g., to

$$( \frac{H W}{{r}^{2}} \times C )$$

to increase the scope of the attention and/or to summarize the information in the keys and values when performing attention, which can have similar effects to downsampling the queries and/or feature maps directly. In some aspects, the local attention block 1010A may be performed without such downsampling, and subsequent attention(s) may be downsampled.

As illustrated, the local attention block 1010A generates the feature map 1015A (e.g., a local attention output tensor). Although not depicted in the illustrated example, in some aspects, the feature map 1015A is generated by de-slicing and/or reshaping the local attention of each slice. For example, as discussed above, a local attention tensor may be generated for each slice, and these local attention tensors may be de-sliced and/or reshaped (e.g., to transform the output from a stacked slice shape to a tensor having the same dimensionality as the input tensor 1005). In other aspects, as only the keys and values may be downsampled by the local attention block 1010A, the feature map 1015A may naturally retain the dimensionality of the input tensor 1005.

As illustrated, this feature map 1015A is provided to a concatenation block 1045. In some aspects, as the feature map 1015A is not downsampled, there is no need for upsampling blocks in the architecture 1000. Though not included in the illustrated example, in some aspects, prior to or during application of the concatenation block 1045, the feature map 1015A may be reshaped (e.g., to three dimensions, such as (H× W×C)).

Additionally, in the illustrated example, the feature map 1015A is provided as input to the local attention block 1010B (which may correspond to the local attention block 710B of FIG. 7). The local attention block 1010B may generally implement the same local attention approach as the local attention block 1010A, but on feature map 1015A and using a (potentially) different set of learned parameters.

Although not included in the illustrated example, in some aspects, the feature map 1015A may undergo slicing and/or reshaping prior to being processed by the local attention block 1010B, as discussed above. For example, in some aspects, if the feature map 1015A has dimensionality (H×W×C), the feature map 1015A may be reshaped into a two-dimensional tensor (e.g., having dimensionality (HW×C)) prior to being provided as input to the local attention block 1010B. In some aspects, if the feature map 1015A is not reshaped (other than by or prior to the concatenation block 1045), the two-dimensional output of the local attention block 1010A (e.g., having size (HW× C)) may be provided directly to the local attention block 1010B without reshaping.

As discussed above, the local attention block 1010B may generally apply local attention to the feature map 1015A (or the reshaped feature map 1015A and/or slices generated therefrom), such as by applying a local attention to each slice using a set of trained local attention parameters (such as the local attention parameters 225 of FIG. 2). As illustrated, the local attention block 1010B outputs a feature map 1015B (e.g., a local attention output tensor).

In the illustrated example, processing the feature map 1015A using the local attention block 1010B may include generating a query matrix, key matrix, and value matrix based on trained weights, as discussed above. In some aspects, the key and value matrices may be further downsampled based on the spatial hyperparameter r, as discussed above, while the query matrix may be unchanged. For example, the key and value matrices of the local attention block 1010B may be downsampled to size

$$( \frac{H W}{{r}^{2}} \times C ) .$$

However, as the feature map 1015B generally matches the dimensionality of the feature map 1015A, the feature map 1015B may have a size and/or dimensionality of (HW×C), as discussed above.

As illustrated, this feature map 1015B is provided to the concatenation block 1045. Though not included in the illustrated example, in some aspects, prior to or during application of the concatenation block 1045, the feature map 1015B may be reshaped (e.g., to three dimensions, such as (H×W×C)). Additionally, in the illustrated example, the feature map 1015B is provided as input to the local attention block 1010C (which may correspond to the local attention block 710C of FIG. 7). The local attention block 1010C may generally implement the same local attention approach as the local attention blocks 1010A and 1010B, but on feature map 1015B and using a (potentially) different set of learned parameters.

Although not included in the illustrated example, in some aspects, the feature map 1015C may undergo slicing and/or reshaping prior to being processed by the local attention block 1010C, as discussed above. For example, in some aspects, if the feature map 1015B has dimensionality (H×W×C), the feature map 1015B may be reshaped into a two-dimensional tensor (e.g., having dimensionality (HW×C)) prior to being provided as input to the local attention block 1010C. In some aspects, if the feature map 1015B is not reshaped (other than by or prior to the concatenation block 1045), the two-dimensional output of the local attention block 1010B (e.g., having size (HW×C)) may be provided directly to the local attention block 1010C without reshaping.

In the illustrated example, processing the feature map 1015B using the local attention block 1010C may include generating a query matrix, key matrix, and value matrix based on trained weights, as discussed above. In some aspects, the key and value matrices may be further downsampled based on the spatial hyperparameter r, as discussed above, while the query matrix may be unchanged. For example, the key and value matrices of the local attention block 1010C may be downsampled to size

$$( \frac{H W}{{r}^{4}} \times C ) .$$

However, as the feature map 1015C generally matches the dimensionality of the feature map 1015B, the feature map 1015C may have a size and/or dimensionality of (HW×C), as discussed above.

The feature map 1015C is then provided to the concatenation block 1045. Though not included in the illustrated example, in some aspects, prior to or during application of the concatenation block 1045, the feature map 1015C may be reshaped (e.g., to three dimensions, such as (H×W×C)). Additionally, in the illustrated example, the feature map 1015C is provided as input to a global attention block 1025 (which may correspond to the global attention block 725 of FIG. 7).

In some aspects, the global attention block 1025 may generally implement global attention as discussed above. In some aspects, the global attention block 1025 may be performed without downsampling the query, key, or value matrices. In other aspects, the global attention block 1025 may similarly downsample the keys and values, as discussed above. For example, the key and value matrices of the global attention block 1025 may be downsampled to a size of

$$( \frac{H W}{{r}^{6}} \times C )$$

As discussed above, the global attention block 1025 may generally apply global attention to the feature map 1015C, such as by pooling or aggregating some elements of the feature map 1015C (e.g., using the slice embedding element 235 of FIG. 2), and applying a global attention to the tensor using a set of trained global attention parameters (such as the global attention parameters 255 of FIG. 2).

As illustrated, the global attention block 1025 generates a feature map 1030. This feature map 1030 is provided to the concatenation block 1045. Though not included in the illustrated example, in some aspects, prior to or during application of the concatenation block 1045, the feature map 1030 may be reshaped (e.g., to three dimensions, such as (H×W×C)).

In the illustrated architecture 1000, the concatenation block 1045 may generally combine or aggregate the feature maps 1015A, 1015B, 1015C, and 1030, such as by concatenating the maps together (e.g., in the depth dimension). For example, if each of the feature maps 1015A, 1015B, 1015C, and 1030 has dimensionality (H×W×C), the concatenation block 1045 may concatenate the maps to generate a concatenated tensor having dimensionality (H×W×4C).

As illustrated, this concatenated tensor is then processed by a channel mixing block 1050 to generate an output tensor 1055 (which may correspond to the output tensor 755 of FIG. 7). For example, the channel mixing block 1050 may perform operations such as one or more convolutions to reduce the size of the concatenated tensor (e.g., such that the output tensor 1055 has dimensionality that matches the input tensor 1005, such as (H×W×C)).

The output tensor 1055 may then be provided as output from the architecture 1000 (e.g., as input to a subsequent layer in the model, or as output from the model).

Although the illustrated example depicts three local attention blocks 1010A-C and a single global attention block 1025, in some aspects, the architecture may include more or fewer local attention blocks 1010 and/or more global attention blocks 1025. In some aspects, by using this sequence of local attentions, the architecture 1000 provides multi-scale local attention (e.g., local attention at multiple different scales, due to the downsampling of keys and values) in conjunction with global attention. Additionally, by downsampling the key and value matrices directly (rather than downsampling between attentions), the architecture 1000 may obviate the separate downsampling blocks as well as the use for separate upsampling blocks while retaining the effects of multi-scale attention that uses independent downsampling (e.g., the architecture 800 of FIG. 8). This can improve robustness and accuracy of the composite slice vision transformers disclosed herein.

Further, in some aspects, the architecture 1000 may dynamically select the number of local attention blocks 1010 to use based on the input tensor 1005, as discussed above. Such a dynamic selection may enable substantial reductions in computational expense. For example, inputs that are less complex (e.g., have fewer foreground objects) and/or are smaller (e.g., have smaller resolution) may be efficiently and accurately processed using fewer local attention operations, thereby reducing the time, power consumption, heat generation, and other computational expense of processing the data. In contrast, inputs that are more complex (e.g., have more foreground objects) and/or are larger (e.g., have larger resolution) may be more accurately processed using more local attention operations, thereby reserving the expended time, power consumption, heat generation, and other computational expense of processing the data for more complex inputs.

Example Architecture for Composite Slice Vision Transformers with Multi-Context Local Attention

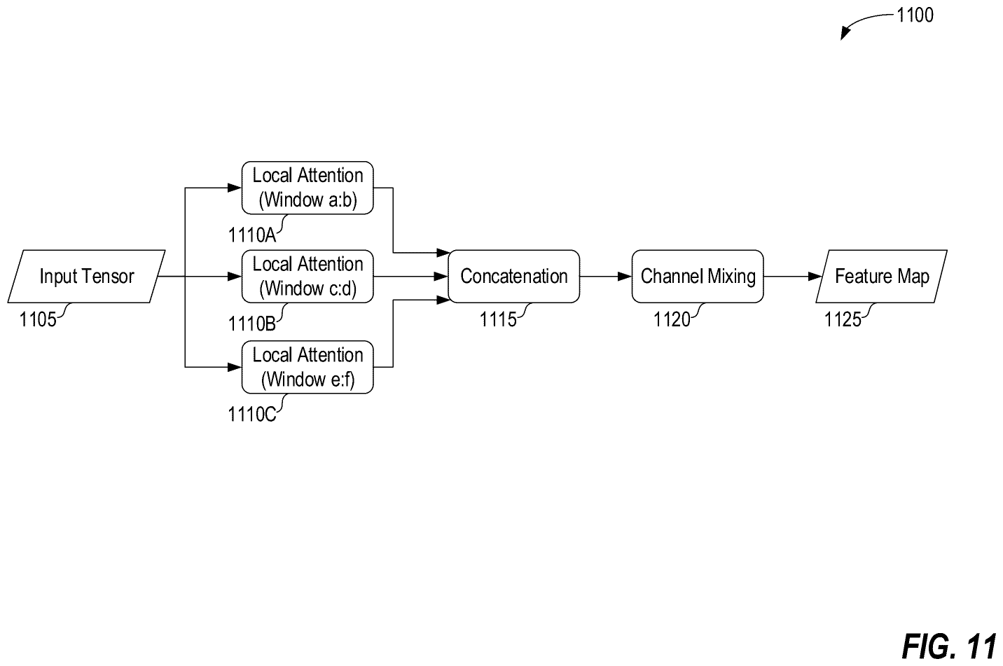

FIG. 11 depicts an example architecture 1100 for composite slice vision transformers with multi-context local attention. In some aspects, the architecture 1100 corresponds to or provides more detail for a slice attention layer, such as the slice attention layer 206 of FIG. 2 and/or the slice attention layer 620 of FIG. 6. More specifically, the architecture 1100 may correspond to the local attention discussed above with reference to the section 215 of FIG. 2, and/or to the local attention blocks 710, 810, 910, and/or 1010 of FIGS. 7, 8, 9, and 10, respectively. That is, local attention blocks 1110A, 1110B, and 1110C (collectively, local attention blocks 1110) may be included as part of a single local attention operation.

In the illustrated example, an input tensor 1105 (which may correspond to the input tensor 705 of FIG. 7) is accessed. For example, the input tensor 1105 may be received as input to a machine learning model (e.g., if the architecture 1100 corresponds to the first layer), or may be received as the output of a prior layer in the model. In some aspects, as discussed above, the input tensor 1105 comprises image data. That is, the input tensor 1105 may be an image (e.g., as input to the model) and/or may include data generated based on an input image (e.g., an attention output or other feature map generated by one or more prior layers based on an input image).

In the illustrated architecture 1100, the input tensor 1105 is provided to three separate local attention blocks 1110. As illustrated, each local attention block 1110 is generally used to generate local attention output based on a different window size and/or shape for the slices. That is, each local attention block 1110 may generate attention output based on slices of different sizes and/or shapes, thereby improving computer vision results (e.g., because predictions based on image data can often be improved by considering non-square context).

In the illustrated example, the local attention block 1110A uses regional slicing for a window aspect ratio of “a:b” (e.g., where each slice is “a” pixels tall and “b” pixels wide). Similarly, the local attention block 1110B uses regional slicing for a window aspect ratio of “c:d” (e.g., where each slice is “c” pixels tall and “d” pixels wide), and the local attention block 1110C uses regional slicing for a window aspect ratio of “e:f” (e.g., where each slice is “e” pixels tall and “f” pixels wide). For example, the local attention block 1110A may be used to provide local attention for square windows (e.g., using slices that are square), the local attention block 1110B may be used to provide local attention for horizontal rectangular windows (e.g., using slices that are wider than they are tall), and the local attention block 1110C may be used to provide local attention for vertical rectangular windows (e.g., using slices that are taller than they are wide).

Although three local attention blocks 1110 are depicted for conceptual clarity, in aspects, the architecture 1100 may be performed using any number of local attention blocks 1110. Similarly, the specific size and/or shape of slices used by each local attention block 1110 may vary depending on the particular implementation. Generally, each local attention block 1110 may compute local attention as discussed above to generate a respective feature map.

In the illustrated example, each local attention block 1110 outputs a respective feature map to a concatenation block 1115. In the illustrated architecture 1100, the concatenation block 1115 may generally combine or aggregate the feature maps from each local attention block 1110, such as by concatenating the maps together (e.g., in the depth dimension). For example, if the feature maps from each local attention block 1110 have dimensionality (H×W×C), the concatenation block 1115 may concatenate the maps to generate a concatenated tensor having dimensionality (H×W×4C). In some aspects, rather than concatenating the feature maps, the concatenation block 1115 may perform other aggregation operations, such as summing or averaging the maps.

As illustrated, this concatenated tensor is then processed by a channel mixing block 1120 to generate an output feature map 1125. For example, the channel mixing block 1120 may perform operations such as one or more convolutions to reduce the size of the concatenated tensor (e.g., such that the feature map 1125 has dimensionality that matches the input tensor 1105, such as (H×W×C)). In some aspects, if the concatenation block 1115 performs other aggregation (such as addition or averaging) rather than concatenation, the channel mixing block 1120 may be unneeded.

The feature map 1125 may then be provided as output from the architecture 1100 (e.g., as output from a local attention section of a vision transformer). That is, the feature map 1125 may correspond to the output of the local attention element 230 of FIG. 2, the local attention output 335 of FIG. 3, the feature maps 715A-C of FIG. 7, 815A-C of FIG. 8, the feature maps 915A-C of FIG. 9, and/or the feature maps 1015A-C of FIG. 10.

In some aspects, by using this combination of local attentions (sequentially or in parallel) with differing windows of attention, the architecture 1100 provides multi-context local attention (e.g., local attention for multiple different contexts/windows, due to the differing sizes and/or shapes of the slices). This can improve robustness and accuracy of the composite slice vision transformers disclosed herein. In some aspects, the multi-context local attention provided by the architecture 1100 may similarly be combined with one or more multi-scale local attention operations discussed above with reference to FIGS. 7, 8, 9, and/or 10 (e.g., using a dynamic or fixed sequence of local attentions, each implementing the architecture 1100). This can enable the system to perform local attention that is multi-scale and multi-context, thereby improving model accuracy and robustness.

Example Method for Generating Attention Output Using Multi-Scale and/or Multi-Context Composite Vision Transformers

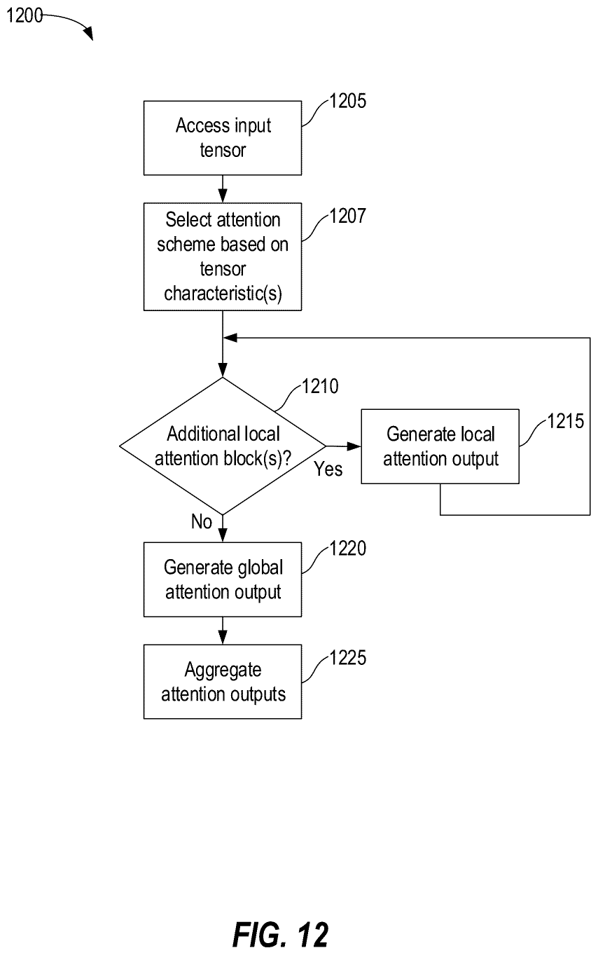

FIG. 12 is a flow diagram depicting an example method 1200 for generating attention output using multi-scale and/or multi-context composite vision transformers. In some aspects, the method 1200 is performed by a machine learning system, and corresponds to processing data using all or a portion of the above-discussed architectures, such as the architecture 200 of FIG. 2, the architecture 600 of FIG. 6, the architecture 700 of FIG. 7, the architecture 800 of FIG. 8, the architecture 900 of FIG. 9, the architecture 1000 of FIG. 10, and/or the architecture 1100 of FIG. 11. In some aspects, the method 1200 can be used during training (e.g., during a forward pass for training data) and/or during inferencing (e.g., using new input data during runtime).

At block 1205, the machine learning system accesses an input tensor. For example, this input tensor may correspond to the transformed version of image pixels 615 and/or the feature map 625A of FIG. 6, input tensor 705 of FIG. 7, the input tensor 805 of FIG. 8, the input tensor 905 of FIG. 9, the input tensor 1005 of FIG. 10, and/or the input tensor 1105 of FIG. 11.

At block 1207, the machine learning system optionally selects an attention scheme (e.g., a number of local attention blocks to use to process the input tensor) based on one or more characteristics of the input tensor. For example, as discussed above, the machine learning system may evaluate the input tensor using a switch component (e.g., the switch component 530 of FIGS. 5 and/or 7) to determine how many local attentions should be applied and/or at what resolution the local attention(s) should be applied. For example, as discussed above, the machine learning component may evaluate the spatial resolution of the input tensor, the complexity (e.g., the number of contextual objects reflected in the salience map of the input tensor), and the like.

At block 1210, the machine learning system determines whether there is at least one additional local attention block in the architecture. For example, as discussed above, the architectures 600, 700, 800, 900, and 1000 of FIGS. 6, 7, 8, 9, and 10, respectively, each may include a number of sequential local attention blocks, and the machine learning system may determine to use any number of these blocks (e.g., between zero and the number of local attentions that are available). If the machine learning model determines that one or more local attention blocks remain (e.g., that the switch component determined to use at least one local attention block that has not yet been used), the method 1200 proceeds to block 1215.

At block 1215, the machine learning system generates a local attention output using one or more local attention blocks (e.g., local attention blocks 710 of FIG. 7, 810 of FIG. 8, local attention blocks 910 of FIG. 9, local attention blocks 1010 of FIG. 10, and/or local attention blocks 1110 of FIG. 11). For example, the local attention output may correspond to the feature map 715A of FIG. 7, the feature map 815A of FIG. 8, the feature map 915A of FIG. 9, the feature map 1015A of FIG. 10, and/or the feature map 1125 of FIG. 11.

As discussed above, the local attention output may be generated based on processing a variety of input data. For example, if, at block 1215, the machine learning system is applying the first local attention that will be applied (e.g., the first that was selected for the input tensor), the machine learning system may process the input tensor (accessed at block 1205) using the local attention block. If, at block 1215, the machine learning system is applying a second or subsequent local attention (e.g., at least one local attention has already been generated for the input tensor), the machine learning system may generate the local attention at block 1215 by processing the previously generated local attention output. In some aspects, as discussed above, the machine learning system may potentially downsample the tensor(s) between local attentions, as discussed above.

Returning to block 1210, if the machine learning system determines that all local attentions have been computed, the method 1200 continues to block 1220. That is, if the machine learning system determines that the desired number of local attention operations (selected by the switch component) have been applied, the method 1200 continues to block 1220. For example, if the machine learning system determines to apply three local attention operations, the machine learning system may determine whether three have been applied. Similarly, if the machine learning system determined to apply only a global attention, the machine learning system may proceed to block 1220.

At block 1220, the machine learning system generates global attention output based on the local attention output generated by the final local attention block. For example, the machine learning system may process the final local attention output (e.g., the feature map 715C of FIG. 7, the feature map 815C of FIG. 8, the feature map 915C of FIG. 9, and/or the feature map 1015C of FIG. 10) using a global attention block, such as the global attention block 725 of FIG. 7, global attention block 825 of FIG. 8, the global attention block 925 of FIG. 9, and/or the global attention block 1025 of FIG. 10) to generate global attention output (e.g., the feature map 730 of FIG. 7, the feature map 830 of FIG. 8, the feature map 930 of FIG. 9, and/or the feature map 1030 of FIG. 10).

At block 1225, the machine learning system aggregates the attention outputs generated at each attention block (e.g., each local attention block and the global attention block) to generate an output feature map (e.g., the feature map 625A and/or 625B of FIG. 6, the output tensor 755 of FIG. 7, the output tensor 855 of FIG. 8, the output tensor 955 of FIG. 9, and/or the output tensor 1055 of FIG. 10). Generally, the particular operations used to aggregate the attentions may vary depending on the particular implementation. For example, in some aspects, aggregating the attention outputs at block 1225 may include the operations of the aggregation component 745 of FIG. 7, the upsampling blocks 835, the concatenation block 845, and/or the channel mixing block 850 of FIG. 8, the operations of the upsampling blocks 935, concatenation block 945, and/or channel mixing block 950 of FIG. 9, and/or the operations of the concatenation block 1045 and/or channel mixing block 1050 of FIG. 10.

In this way, the machine learning system can generate multi-scale and/or multi-context transformer output. That is, as discussed above, the output may be referred to as multi-scale to indicate that the output is generated using multiple levels of local attention (e.g., attention at multiple scales), which may include downsampling the input to one or more attention blocks, downsampling the query, key, and/or value matrices within one or more attention blocks, and the like. Further, the output may be referred to as multi-context to indicate that the output is generated using local attention having different contexts (e.g., different window sizes and/or shapes for the slices generated during the local attention operations). This multi-scale and/or multi-context attention output can therefore result in substantially improved model performance, as discussed above.

Further, as discussed above, by dynamically selecting the number of levels of local attention that are used based on the input tensor itself, the machine learning system may enable substantial reductions in computational expense. For example, inputs that are less complex (e.g., have fewer foreground objects) and/or are smaller (e.g., have smaller resolution) may be efficiently and accurately processed using fewer local attention operations, thereby reducing the time, power consumption, heat generation, and other computational expense of processing the data. In contrast, inputs that are more complex (e.g., have more foreground objects) and/or are larger (e.g., have larger resolution) may be more accurately processed using more local attention operations, thereby reserving the expended time, power consumption, heat generation, and other computational expense of processing the data for more complex inputs.

As discussed above, this output feature map may then be used for a variety of purposes, including as input to a subsequent layer of a model. That is, in some aspects, a full neural network architecture may be constructed using a sequence of multi-scale and/or multi-context transformers (each implemented using the architectures 700, 800, 900, 1000, and/or 1100 of FIGS. 7, 8, 9, 10, and/or 11, as discussed above), such as discussed above with reference to the architecture 600 of FIG. 6. In such an aspect, the method 1200 may therefore be repeated for each layer (e.g., each slice attention layer 620) of the model (e.g., of the machine learning model 602).

As one example, a neural network backbone implemented using the architectures and techniques described herein may include two layers of composite slice vision transformers (each having three local attention blocks and one global attention block), followed by two additional layers of composite slice vision transformers (each having two local attention blocks and one global attention block), followed by ten layers of composite slice vision transformers (each having one local attention block and one global attention block), and finally followed by four layers of self-attention layers.

Various prediction heads (e.g., classifiers or regression layers) can then be added to the end of this backbone to perform various computer vision tasks, such as classification, detection, segmentation, and the like. In some aspects, the model (including the backbone and the prediction head(s)) can then be trained end-to-end (e.g., using labeled exemplars and backpropagation) to perform a wide variety of computer vision tasks with improved accuracy, reduced computational expense during training and/or inferencing, and generally improved robustness.

### Example Method for Generating Composite Slice Vision Transformer Output

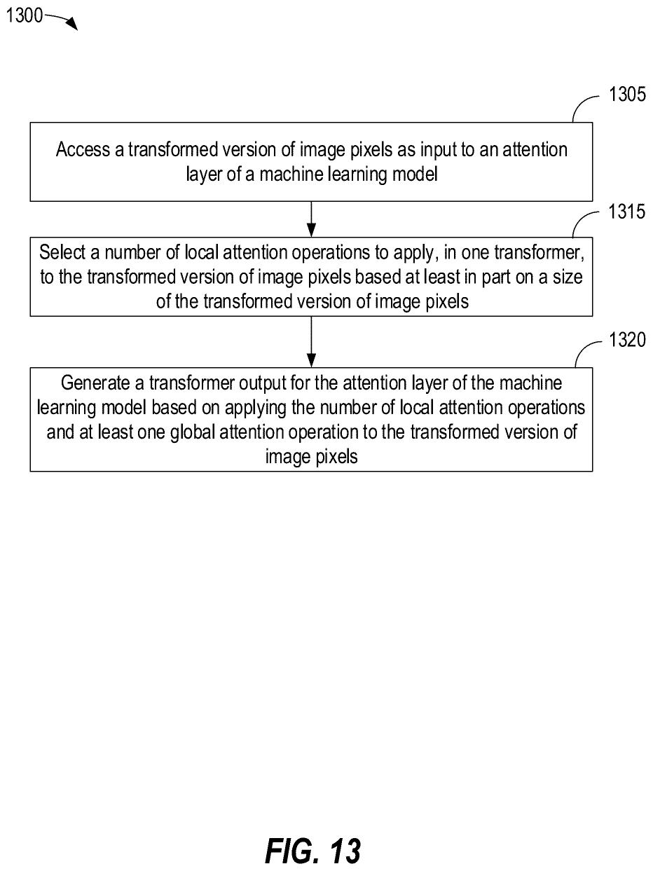

FIG. 13 is a flow diagram depicting an example method 1300 for generating composite slice vision transformer output. In some aspects, the method 1300 is performed by a machine learning system, such as the machine learning system discussed above with reference to FIG. 12.

At block 1305, a transformed version of image pixels is accessed as input to an attention layer of a machine learning model.

At block 1315, a number of local attention operations to apply, in one transformer, to the transformed version of image pixels is selected based at least in part on a size of the transformed version of image pixels.

At block 1320, a transformer output for the attention layer of the machine learning model is generated based on applying the number of local attention operations and at least one global attention operation to the transformed version of image pixels.

In some aspects, the method 1300 further includes generating a saliency map based on the transformed version of image pixels, and determining a semantic complexity of the transformed version of image pixels based on the saliency map.

In some aspects, selecting the number of local attention operations comprises selecting the number of local attention operations based on a number of contextual objects indicated in the saliency map.

In some aspects, selecting the number of local attention operations comprises comparing the number of contextual objects against one or more thresholds to select the number of local attention operations.

In some aspects, the selected number of local attention operations is directly proportional to the number of contextual objects.

In some aspects, selecting the number of local attention operations comprises selecting at least two local attention operations based on a determination that the number of contextual objects satisfies a defined threshold.

In some aspects, selecting the number of local attention operations comprises obtaining a display resolution of a display device included in the processing system, and selecting three local attention operations, in the transformer, when a display resolution is set to at least a maximum size of the transformed version of image pixels and the number of contextual objects is three or more.

In some aspects, selecting the number of local attention operations comprises obtaining a display resolution of a display device included in the processing system, and selecting two local attention operations, in the transformer, when a display resolution is set to less than a maximum size of the transformed version of image pixels and the number of contextual objects is two.

In some aspects, selecting the number of local attention operations comprises obtaining a display resolution of a display device included in the processing system, and selecting one local attention operations, in the transformer, when a display resolution is set to less than a maximum size of the transformed version of image pixels and the number of contextual objects is one.

In some aspects, selecting the number of local attention operations comprises obtaining a display resolution of a display device included in the processing system, and selecting one local attention operations, in the transformer, when a display resolution is set to a smallest size of the transformed version of image pixels and the number of contextual objects is one.

In some aspects, the selected number of local attention operations is directly proportional to the size of the transformed version of image pixels.

In some aspects, selecting the number of local attention operations comprises selecting at least two local attention operations based on a determination that the size satisfies a defined threshold.

In some aspects, the number of local attention operations is selected based further on a resolution of a display that will be used to display output of the machine learning model.

In some aspects, the selected number of local attention operations is directly proportional to the resolution.

In some aspects, the method 1300 further includes capturing image data via a camera, and transforming the image data to generate the transformed version of image pixels.

In some aspects, the method 1300 further includes transmitting the transformer output to a receiver.

In some aspects, the method 1300 further includes generating an output prediction of the machine learning model based at least in part on the transformer output.

In some aspects, the method 1300 further includes displaying the output prediction.

In some aspects, the output prediction comprises at least one of: a depth map, a classification, or a segmentation map.

In some aspects, generating the transformer output comprises: generating a first local attention output based on processing the transformed version of image pixels using a first sliced local attention operation at a first scale, generating a second local attention output based on the first local attention output and a second sliced local attention operation at a second scale, generating a global attention output based on the second local attention output and a global attention operation, and generating the transformer output based on the first local attention output, the second local attention output, and the global attention output.

### Example Processing System for Composite Slice Vision Transformers

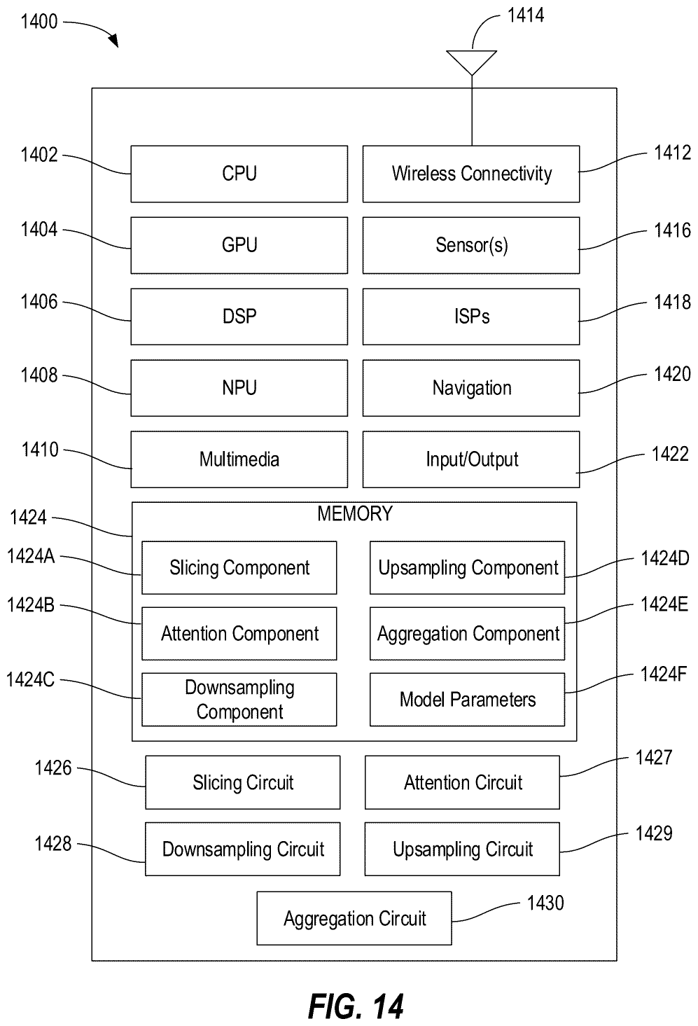

In some aspects, the workflows, techniques, architectures, and methods described with reference to FIGS. 1-13 may be implemented on one or more devices or systems. FIG. 14 depicts an example processing system 1400 configured to perform various aspects of the present disclosure, including, for example, the techniques and methods described with respect to FIGS. 1-13. In some aspects, the processing system 1400 may correspond to one or more machine learning systems, such as the machine learning system that performs the method 1200 of FIG. 12 and/or the method 1300 of FIG. 13. For example, the processing system 1400 may correspond to a device or system that trains model(s) including one or more composite slice vision transformers and/or that uses one or more model(s) including one or more composite slice vision transformers during runtime inferencing. Although depicted as a single system for conceptual clarity, in some aspects, as discussed above, the operations described below with respect to the processing system 1400 may be distributed across any number of devices or systems (e.g., where one system trains the model(s) and one uses the trained model(s) for inferencing).

The processing system 1400 includes a central processing unit (CPU) 1402, which in some examples may be a multi-core CPU. Instructions executed at the CPU 1402 may be loaded, for example, from a program memory associated with the CPU 1402 or may be loaded from a memory partition (e.g., a partition of memory 1424).

The processing system 1400 also includes additional processing components tailored to specific functions, such as a graphics processing unit (GPU) 1404, a digital signal processor (DSP) 1406, a neural processing unit (NPU) 1408, a multimedia component 1410 (e.g., a multimedia processing unit), and a wireless connectivity component 1412.

An NPU, such as NPU 1408, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 1408, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 1408 is a part of one or more of the CPU 1402, the GPU 1404, and/or the DSP 1406.

In some examples, the wireless connectivity component 1412 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and/or other wireless data transmission standards. The wireless connectivity component 1412 is further coupled to one or more antennas 1414.

The processing system 1400 may also include one or more sensor processing units 1416 associated with any manner of sensor, one or more image signal processors (ISPs) 1418 associated with any manner of image sensor, and/or a navigation processor 1420, which may include satellite-based positioning system components (e.g., GPS or GLONASS), as well as inertial positioning system components.

The processing system 1400 may also include one or more input and/or output devices 1422, such as screens, touch-sensitive surfaces (including touch-sensitive displays), physical buttons, speakers, microphones, and the like.

In some examples, one or more of the processors of the processing system 1400 may be based on an ARM or RISC-V instruction set.

The processing system 1400 also includes the memory 1424, which is representative of one or more static and/or dynamic memories, such as a dynamic random access memory, a flash-based static memory, and the like. In this example, the memory 1424 includes computer-executable components, which may be executed by one or more of the aforementioned processors of the processing system 1400.

In particular, in this example, the memory 1424 includes a slicing component 1424A, an attention component 1424B, a downsampling component 1424C, an upsampling component 1424D, and an aggregation component 1424E. The memory 1424 further includes model parameters 1424F for one or more models (e.g., attention parameters for one or more local and/or global attention blocks, such as the local attention parameters 225 and/or the global attention parameters 255, each of FIG. 2). Although not included in the illustrated example, in some aspects the memory 1424 may also include other components, such as a training component that orchestrates and/or performs model training using the depicted components, an inferencing component that orchestrates and/or performs inferencing using the depicted components, and the like. Though depicted as discrete components for conceptual clarity in FIG. 14, the illustrated components (and others not depicted) may be collectively or individually implemented in various aspects.

The processing system 1400 further comprises a slicing circuit 1426, an attention circuit 1427, a downsampling circuit 1428, an upsampling circuit 1429, and an aggregation circuit 1430. The depicted circuits, and others not depicted, may be configured to perform various aspects of the techniques described herein.

For example, the slicing component 1424A and/or the slicing circuit 1426 (which may correspond to slicing layer 210 of FIG. 2) may be used to generate slices for local attention blocks, as discussed above. For example, the slicing component 1424A and/or the slicing circuit 1426 may use regional and/or axial slicing operations prior to or within one or more local attention blocks, as discussed above.

The attention component 1424B and/or the attention circuit 1427 (which may correspond to the section 215 and/or the section 245 of FIG. 2, the local attention blocks 710 of FIG. 7, the local attention blocks 810 and/or the global attention block 825 of FIG. 8, the local attention blocks 910 and/or the global attention block 925 of FIG. 9, the local attention blocks 1010 and/or the global attention block 1025 of FIG. 10, and/or the local attention blocks 1110 of FIG. 11) may be used to perform local and/or global self-attention based on attention parameters (e.g., the model parameters 1424F, as discussed above. In some aspects, as discussed above, the attention component 1424B and/or the attention circuit 1427 may dynamically determine and apply varying levels of local attention (e.g., using a switch such as the switch component 530 of FIGS. 5 and/or 7), as discussed above.

The downsampling component 1424C and/or the downsampling circuit 1428 (which may correspond to the downsampling blocks 820 of FIG. 8, and/or may be used by the attention component 1424B and/or attention circuit 1427 to downsample key, query, and/or value matrices) may be used to downsample tensors based on one or more spatial scaling hyperparameters (e.g., r), as discussed above.

The upsampling component 1424D and/or the upsampling circuit 1429 (which may correspond to the upsampling blocks 835 of FIG. 8 and/or the upsampling blocks 935 of FIG. 9) may be used to upsample tensors based on the one or more spatial scaling hyperparameters, as discussed above.

The aggregation component 1424E and/or the aggregation circuit 1430 (which may correspond to the aggregation component 745 of FIG. 7, the concatenation block 845 and/or the channel mixing block 850 of FIG. 8, the concatenation block 945 and/or the channel mixing block 950 of FIG. 9, the concatenation block 1045 and/or the channel mixing block 1050 of FIG. 10, and/or the concatenation block 1115 and/or the channel mixing block 1120 of FIG. 11) may be used to aggregate attention outputs from various blocks (e.g., at various scales and/or for various contexts) to generate the overall attention output of one or more vision transformers, as discussed above.

Though depicted as separate components and circuits for clarity in FIG. 14, the slicing circuit 1426, the attention circuit 1427, the downsampling circuit 1428, the upsampling circuit 1429, and the aggregation circuit 1430 may collectively or individually be implemented in other processing devices of the processing system 1400, such as within the CPU 1402, the GPU 1404, the DSP 1406, the NPU 1408, and the like.

Generally, the processing system 1400 and/or components thereof may be configured to perform the methods described herein.

Notably, in other aspects, elements of the processing system 1400 may be omitted, such as where the processing system 1400 is a server computer or the like. For example, the multimedia component 1410, the wireless connectivity component 1412, the sensor processing units 1416, the ISPs 1418, and/or the navigation processor 1420 may be omitted in other aspects. Further, aspects of the processing system 1400 may be distributed between multiple devices.

### Example Clauses

Implementation examples are described in the following numbered clauses:

Clause 1: A method, comprising: accessing an input tensor; determining a set of characteristics of the input tensor based at least in part on (i) a size of the input tensor or (ii) a semantic complexity of the input tensor; selecting a number of local attention operations to apply to the input tensor based at least in part on the set of characteristics; and generating a transformer output based on applying the number of local attention operations and at least one global attention operation to the input tensor.

Clause 2: A method according to Clause 1, wherein determining the set of characteristics comprises generating a saliency map based on the input tensor, wherein the semantic complexity of the input tensor is determined based on the saliency map.

Clause 3: A method according to any of Clauses 1-2, wherein selecting the number of local attention operations comprises comparing the set of characteristics against one or more thresholds to select the number of local attention operations.

Clause 4: A method according to any of Clauses 1-3, wherein generating the transformer output comprises: generating a first local attention output based on processing the input tensor using a first sliced local attention operation at a first scale; generating a second local attention output based on the first local attention output and a second sliced local attention operation at a second scale; generating a global attention output based on the second local attention output and a global attention operation; and generating the transformer output based on the first local attention output, the second local attention output, and the global attention output.

Clause 5: A method according to Clause 4, wherein generating the second local attention output comprises: slicing the first local attention output using a slicing operation to generate a plurality of slices; processing each of the plurality of slices using the second sliced local attention operation to generate a plurality of local attention tensors; and de-slicing the plurality of local attention tensors to generate the second local attention output.

Clause 6: A method according to Clause 5, wherein the slicing operation comprises at least one of regional slicing or axial slicing.

Clause 7: A method according to any of Clauses 5-6, wherein processing each of the plurality of slices using the second sliced local attention operation comprises, for a first slice of the plurality of slices: generating a query vector based on the first slice and a trained query parameter; downsampling the query vector based on a spatial hyperparameter to generate a downsampled query vector; and generating a first local attention tensor of the plurality of local attention tensors based on the downsampled query vector.

Clause 8: A method according to any of Clauses 5-7, wherein processing each of the plurality of slices using the second sliced local attention operation comprises, for a first slice of the plurality of slices: generating a key vector based on the first slice and a trained key parameter; generating a value vector based on the first slice and a trained value parameter; downsampling the key vector and the value vector based on a spatial hyperparameter to generate a downsampled key vector and a downsampled value vector; and generating a first local attention tensor of the plurality of local attention tensors based on the downsampled key vector and downsampled query vector.

Clause 9: A method according to any of Clauses 4-8, wherein generating the second local attention output comprises: downsampling the first local attention output based on a spatial hyperparameter to generate a downsampled first local attention output; and processing the downsampled first local attention output using the second sliced local attention operation.

Clause 10: A method according to any of Clauses 4-9, wherein generating the transformer output comprises upsampling the second local attention output and the global attention output based on a spatial hyperparameter to generate an upsampled second local attention output and an upsampled global attention output.

Clause 11: A method according to Clause 10, wherein generating the transformer output comprises: concatenating the upsampled second local attention output and the upsampled global attention output to generate a concatenated tensor; and processing the concatenated tensor using a channel mixing operation.

Clause 12: A method according to any of Clauses 4-11, wherein generating the transformer output comprises: concatenating the first local attention output, the second local attention output, and the global attention output to generate a concatenated tensor; and processing the concatenated tensor using a channel mixing operation.

Clause 13: A method according to any of Clauses 4-12, wherein generating the first local attention output comprises: generating a first feature map based on a first window aspect ratio; generating a second feature map based on a second window aspect ratio; and combining the first and second feature maps to generate the first local attention output.

Clause 14: A method, comprising: accessing an input tensor; generating a first local attention output based on processing the input tensor using a first sliced local attention operation at a first scale; generating a second local attention output based on the first local attention output and a second sliced local attention operation at a second scale; generating a global attention output based on the second local attention output and a global attention operation; and generating a multi-scale transformer output based on the first local attention output, the second local attention output, and the global attention output.

Clause 15: A method according to Clause 14, wherein generating the second local attention output comprises: slicing the first local attention output using a slicing operation to generate a plurality of slices; processing each of the plurality of slices using the second sliced local attention operation to generate a plurality of local attention tensors; and de-slicing the plurality of local attention tensors to generate the second local attention output.

Clause 16: A method according to Clause 15, wherein the slicing operation comprises at least one of regional slicing or axial slicing.

Clause 17: A method according to Clause 15, wherein processing each of the plurality of slices using the second sliced local attention operation comprises, for a first slice of the plurality of slices: generating a query vector based on the first slice and a trained query parameter; downsampling the query vector based on a spatial hyperparameter to generate a downsampled query vector; and generating a first local attention tensor of the plurality of local attention tensors based on the downsampled query vector.

Clause 18: A method according to Clause 15, wherein processing each of the plurality of slices using the second sliced local attention operation comprises, for a first slice of the plurality of slices: generating a key vector based on the first slice and a trained key parameter; generating a value vector based on the first slice and a trained value parameter; downsampling the key vector and the value vector based on a spatial hyperparameter to generate a downsampled key vector and a downsampled value vector; and generating a first local attention tensor of the plurality of local attention tensors based on the downsampled key vector and downsampled query vector.

Clause 19: A method according to any of Clauses 14-18, wherein generating the second local attention output comprises: downsampling the first local attention output based on a spatial hyperparameter to generate a downsampled first local attention output; and processing the downsampled first local attention output using the second sliced local attention operation.

Clause 20: A method according to any of Clauses 14-19, wherein generating the multi-scale transformer output comprises upsampling the second local attention output and the global attention output based on a spatial hyperparameter to generate an upsampled second local attention output and an upsampled global attention output.

Clause 21: A method according to Clause 20, wherein generating the multi-scale transformer output comprises: concatenating the upsampled second local attention output and the upsampled global attention output to generate a concatenated tensor; and processing the concatenated tensor using a channel mixing operation.

Clause 22: A method according to any of Clauses 14-21, wherein generating the multi-scale transformer output comprises: concatenating the first local attention output, the second local attention output, and the global attention output to generate a concatenated tensor; and processing the concatenated tensor using a channel mixing operation.

Clause 23: A method according to any of Clauses 14-22, wherein generating the first local attention output comprises: generating a first feature map based on a first window aspect ratio; generating a second feature map based on a second window aspect ratio; and combining the first and second feature maps to generate the first local attention output.

Clause 24: A method, comprising: accessing a transformed version of image pixels as input to an attention layer of a machine learning model; selecting a number of local attention operations to apply, in one transformer, to the transformed version of image pixels based at least in part on a size of the transformed version of image pixels; and generating a transformer output for the attention layer of the machine learning model based on applying the number of local attention operations and at least one global attention operation to the transformed version of image pixels.

Clause 25: A method according to Clause 24, further comprising generating a saliency map based on the transformed version of image pixels, and determining a semantic complexity of the transformed version of image pixels based on the saliency map.

Clause 26: A method according to Clause 25, wherein selecting the number of local attention operations comprises selecting the number of local attention operations based on a number of contextual objects indicated in the saliency map.

Clause 27: A method according to Clause 26, wherein selecting the number of local attention operations comprises comparing the number of contextual objects against one or more thresholds to select the number of local attention operations.

Clause 28: A method according to any of Clauses 26-27, wherein the selected number of local attention operations is directly proportional to the number of contextual objects.

Clause 29: A method according to any of Clauses 26-28, wherein selecting the number of local attention operations comprises selecting at least two local attention operations based on a determination that the number of contextual objects satisfies a defined threshold.

Clause 30: A method according to any of Clauses 26-29, wherein selecting the number of local attention operations comprises obtaining a display resolution of a display device included in the processing system, and selecting three local attention operations, in the transformer, when a display resolution is set to at least a maximum size of the transformed version of image pixels and the number of contextual objects is three or more.

Clause 31: A method according to any of Clauses 26-30, wherein selecting the number of local attention operations comprises obtaining a display resolution of a display device included in the processing system, and selecting two local attention operations, in the transformer, when a display resolution is set to less than a maximum size of the transformed version of image pixels and the number of contextual objects is two.

Clause 32: A method according to any of Clauses 26-31, wherein selecting the number of local attention operations comprises obtaining a display resolution of a display device included in the processing system, and selecting one local attention operations, in the transformer, when a display resolution is set to less than a maximum size of the transformed version of image pixels and the number of contextual objects is one.

Clause 33: A method according to any of Clauses 26-32, wherein selecting the number of local attention operations comprises obtaining a display resolution of a display device included in the processing system, and selecting one local attention operations, in the transformer, when a display resolution is set to a smallest size of the transformed version of image pixels and the number of contextual objects is one.

Clause 34: A method according to any of Clauses 24-33, wherein the selected number of local attention operations is directly proportional to the size of the transformed version of image pixels.

Clause 35: A method according to Clause 34, wherein selecting the number of local attention operations comprises selecting at least two local attention operations based on a determination that the size satisfies a defined threshold.

Clause 36: A method according to any of Clauses 24-35, wherein the number of local attention operations is selected based further on a resolution of a display that will be used to display output of the machine learning model.

Clause 37: A method according to Clause 36, wherein the selected number of local attention operations is directly proportional to the resolution.

Clause 38: A method according to any of Clauses 24-37, further comprising capturing image data via a camera, and transforming the image data to generate the transformed version of image pixels.

Clause 39: A method according to any of Clauses 24-38, further comprising transmitting the transformer output to a receiver.

Clause 40: A method according to any of Clauses 24-39, further comprising generating an output prediction of the machine learning model based at least in part on the transformer output.

Clause 41: A method according to Clause 40, further comprising displaying the output prediction.

Clause 42: A method according to any of Clauses 40-41, wherein the output prediction comprises at least one of: a depth map, a classification, or a segmentation map.

Clause 43: A method according to any of clauses 24-42, wherein generating the transformer output comprises: generating a first local attention output based on processing the transformed version of image pixels using a first sliced local attention operation at a first scale, generating a second local attention output based on the first local attention output and a second sliced local attention operation at a second scale, generating a global attention output based on the second local attention output and a global attention operation, and generating the transformer output based on the first local attention output, the second local attention output, and the global attention output.

Clause 44: A processing system comprising: a memory comprising computer-executable instructions; and one or more processors configured to execute the computer-executable instructions and cause the processing system to perform a method in accordance with any of Clauses 1-43.

Clause 45: A processing system comprising means for performing a method in accordance with any of Clauses 1-43.

Clause 46: A non-transitory computer-readable medium comprising computer-executable instructions that, when executed by one or more processors of a processing system, cause the processing system to perform a method in accordance with any of Clauses 1-43.

Clause 47: A computer program product embodied on a computer-readable storage medium comprising code for performing a method in accordance with any of Clauses 1-43.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system in a device, comprising:
a memory configured to store machine learning model parameters; and
one or more processors, coupled to the memory, configured to:
access a transformed version of image pixels as input to an attention layer of a machine learning model;
select a number of local attention operations to apply, in one transformer, to the transformed version of image pixels based at least in part on a size of the transformed version of image pixels; and
generate a transformer output for the attention layer of the machine learning model based on applying the number of local attention operations and at least one global attention operation to the transformed version of image pixels.

2. The processing system of claim 1, wherein the one or more processors are configured to:
generate a saliency map based on the transformed version of image pixels; and
determine a semantic complexity of the transformed version of image pixels based on the saliency map.

3. The processing system of claim 2, wherein, to select the number of local attention operations, the one or more processors are configured to select the number of local attention operations based on a number of contextual objects indicated in the saliency map.

4. The processing system of claim 3, wherein, to select the number of local attention operations, the one or more processors are configured to compare the number of contextual objects against one or more thresholds to select the number of local attention operations.

5. The processing system of claim 3, wherein the selected number of local attention operations is directly proportional to the number of contextual objects.

6. The processing system of claim 3, wherein, to select the number of local attention operations, the one or more processors are configured to select at least two local attention operations based on a determination that the number of contextual objects satisfies a defined threshold.

7. The processing system of claim 3, wherein, to select the number of local attention operations, the one or more processors are configured to:
obtain a display resolution of a display device included in the processing system; and
select three local attention operations, in the transformer, when a display resolution is set to at least a maximum size of the transformed version of image pixels and the number of contextual objects is three or more.

8. The processing system of claim 3, wherein, to select the number of local attention operations, the one or more processors are configured to:
obtain a display resolution of a display device included in the processing system; and
select two local attention operations, in the transformer, when a display resolution is set to less than a maximum size of the transformed version of image pixels and the number of contextual objects is two.

9. The processing system of claim 3, wherein, to select the number of local attention operations, the one or more processors are configured to:
obtain a display resolution of a display device included in the processing system; and
select one local attention operations, in the transformer, when a display resolution is set to less than a maximum size of the transformed version of image pixels and the number of contextual objects is one.

10. The processing system of claim 3, wherein, to select the number of local attention operations, the one or more processors are configured to:
obtain a display resolution of a display device included in the processing system; and
select one local attention operations, in the transformer, when a display resolution is set to a smallest size of the transformed version of image pixels and the number of contextual objects is one.

11. The processing system of claim 1, wherein the selected number of local attention operations is directly proportional to the size of the transformed version of image pixels.

12. The processing system of claim 11, wherein, to select the number of local attention operations, the one or more processors are configured to select at least two local attention operations based on a determination that the size satisfies a defined threshold.

13. The processing system of claim 1, wherein the number of local attention operations is selected based further on a resolution of a display that will be used to display output of the machine learning model.

14. The processing system of claim 13, wherein the selected number of local attention operations is directly proportional to the resolution.

15. The processing system of claim 1, further comprising a camera coupled to the one or more processors, wherein the camera is configured to capture image data, and wherein the one or more processors are configured to transform the image data to generate the transformed version of image pixels.

16. The processing system of claim 1, further comprising a transmitter coupled to the one or more processors, wherein the transmitter is configured to transmit the transformer output to a receiver.

17. The processing system of claim 1, wherein the one or more processors are configured to generate an output prediction of the machine learning model based at least in part on the transformer output.

18. The processing system of claim 17, further comprising a display coupled to the one or more processors, wherein the display is configured to display the output prediction.

19. The processing system of claim 17, wherein the output prediction comprises at least one of: a depth map, a classification, or a segmentation map.

20. The processing system of claim 1, wherein, to generate the transformer output, the one or more processors are configured to:
generate a first local attention output based on processing the transformed version of image pixels using a first sliced local attention operation at a first scale;
generate a second local attention output based on the first local attention output and a second sliced local attention operation at a second scale;
generate a global attention output based on the second local attention output and a global attention operation; and
generate the transformer output based on the first local attention output, the second local attention output, and the global attention output.
